(19) United States
(12) Patent Application Publication
(10) Pub. No.: US 2011/0302548 A1
(43) Pub. Date: Dec. 8, 2011

(54) DELAY LIBRARY GENERATION DEVICE AND METHOD

(75) Inventor: Masashi ARAYAMA, Kawasaki (JP)

(73) Assignee: FUJITSU LIMITED, Kawasaki-shi (JP)

(21) Appl. No.: 13/151,589

(22) Filed: Jun. 2, 2011

(30) Foreign Application Priority Data
Jun. 7, 2010 (JP) 2010-130008

(51) Int. Cl. G06F 17/50

(52) U.S. Cl. 716/136

(57) ABSTRACT

A delay library generation device includes a grouping unit that generates a group including an output terminal of a sequential logic circuit and an input terminal of the sequential logic circuit that influences the output terminal based on circuit information of the sequential logic circuit, a signal pattern generation unit that generates a signal pattern set for the input terminal of the sequential logic circuit for each generated group based on a true value table of the sequential logic circuit and a library generation unit that measures a delay of the sequential logic circuit for each group and generates a delay library of the sequential logic circuit based on the measured delay.

### CROSS-REFERENCE TO RELATED APPLICATION

This application is based upon and claims priority to prior Japanese Patent Application No. 2010-130008 filed on Jun. 7, 2010 in the Japan Patent Office, the entire contents of which are incorporated herein by reference.

### FIELD

An embodiment of the present invention discussed herein relates to a delay library generation device, program and method.

### BACKGROUND

In general, analysis of a delay of a semiconductor circuit such as, for example, a large scale integration (LSI) circuit is performed by static timing analysis (STA) using a delay library. The delay library is also called a timing analysis library, and the delay library is generated per cell macro incorporated into the LSI circuit. As the cell macros, for example, a combinational logic circuit and a sequential logic circuit such as a flip-flop (hereinafter, referred to as “FF”) and the like are included. Characteristic information such as timing constraints (a setup time and a hold time), a delay value and the like of each object micro which has been obtained by simulation is held in the delay library.

Preparation of the delay library of a combinational logic circuit is automated to some extent. In the above mentioned case, the delay library of the object combinational logic circuit is generated in such a manner that a combination of signals is simply given to an input terminal of the object combinational logic circuit to perform simulation, thereby obtaining the characteristic information such as the delay value thereof and the like.

On the other hand, it may be difficult to prepare the delay library of an FF simply by conceiving of a simple combination of signals to be given to its input terminal for reasons as follows.

That is, signal importation and value holding are performed with transition of a clock signal to High (“1”) or Low (“0”) in an FF. Therefore, first, it may be desirable to recognize the input terminal of the clock signal, that is, a clock terminal in preparation of the delay library of the FF. Next, it may be desirable to perform time-considered analysis based on pre-transition and post-transition statuses of the clock signal for analysis of signal importation and value holding in the FF. In addition, since an imported signal is influenced by a set signal and a reset signal, it may be also desirable to recognize input terminals, that is, a set terminal and a reset terminal of the above signals.

Since the FF operates with transition of the clock signal, the set signal and the reset signal as described above, it may be difficult to prepare the delay library of the FF simply by giving a simple combination of signals to the input terminal of the FF as a signal pattern. In addition, if it is simply tried to simultaneously analyze all the terminals, the number of combinations of signals will be greatly increased and hence it will become difficult to finish analysis in an actual estimated time.

Therefore, it may be difficult to automatically generate a signal pattern to be given to the input terminal of the FF for preparation of the delay library of the FF and under present conditions, the signal pattern is generated with the aid of a person such as a designer or others. Then, the delay library of the FF is generated based on the signal pattern which has been manually generated.

Incidentally, in development of a very high speed LSI circuit having a clock frequency higher than several GHz, a variety of cell micros are prepared for the same logic and the cell micros are combined with one another to design a circuit for realizing its high frequency performance and for realizing further power saving in recent years. Then, timing adjustment between FFs may be indispensable to attain a desirable frequency performance and delay libraries of various cell micros are used for timing calculation.

A variety of circuits are prepared for realizing the FF, and delay libraries of the respective variety of circuits may be desirable. Since the FF has a function of retaining a value with a clock signal or the like, a time-based concept may be desirable and hence it may be difficult to prepare the delay library of the FF simply by conceiving of a simple combination of signals as described above. Therefore, in preparation of the delay library of the FF, the signal pattern for use in preparation of the library is manually generated.

Since the signal pattern is manually generated as described above, much time is taken for preparing the delay library for the FF. In particular, the number of steps and time for preparing the delay libraries for the FF may be greatly increased with increasing the number of variations of the FF. In addition, more labor and time may be taken for preparing the delay library of a multi-bit FF including many input terminals.

Art relating to a delay library is disclosed in patent documents listed below, for example.

[Patent Document 1] Japanese Laid-open Patent Publication No. 6-274566

[Patent Document 2] Japanese Laid-open Patent Publication No. 7-311791

[Patent Document 3] Japanese Laid-open Patent Publication No. 9-153073

[Patent Document 4] Japanese Laid-open Patent Publication No. 2005-196265.

### SUMMARY

According to an aspect of the invention, a delay library generation device includes a grouping unit that generates a group including an output terminal of a sequential logic circuit and an input terminal of the sequential logic circuit that influences the output terminal based on circuit information of the sequential logic circuit, a signal pattern generation unit that generates a signal pattern set for the input terminal of the sequential logic circuit for each generated group based on a true value table of the sequential logic circuit, and a library generation unit that measures delay information indicating a delay of the sequential logic circuit per group and generates a delay library of the sequential logic circuit based on the measured delay information.

### BRIEF DESCRIPTION OF THE DRAWINGS

FIG. 1 is a block diagram illustrating an example functional configuration of a delay library generation device according to a first embodiment;

FIG. 2 is an example flowchart illustrating procedures of a process of analyzing a delay of an LSI circuit;

FIG. 3 is a diagram illustrating example delay calculation of an LSI circuit;

FIG. 4 is an example flowchart illustrating the outline of procedures of a delay library generating process according to the first embodiment;

FIG. 5 is an example flowchart illustrating procedures of a grouping process according to the first embodiment;

FIG. 6 is a diagram illustrating example procedures of the grouping process according to the first embodiment;

FIG. 7 is an example flowchart illustrating procedures of a true value table dividing process according to the first embodiment;

FIG. 8A is a diagram illustrating example procedures of the true value table dividing process according to the first embodiment;

FIG. 8B is a diagram illustrating example procedures of the true value table dividing process according to the first embodiment;

FIG. 8C is a diagram illustrating example procedures of the true value table dividing process according to the first embodiment;

FIG. 9 is an example flowchart illustrating procedures of a terminal type deciding process according to the first embodiment;

FIG. 10 is an example flowchart illustrating procedures of a clock terminal deciding process according to the first embodiment;

FIG. 11 is an example flowchart illustrating procedures of a set terminal deciding process according to the first embodiment;

FIG. 12 is an example flowchart illustrating procedures of a reset terminal deciding process according to the first embodiment;

FIG. 13 is a diagram illustrating example procedures of the terminal type deciding process according to the first embodiment;

FIG. 14 is an example flowchart illustrating procedures of a signal pattern generating process and procedures of a delay measuring process according to the first embodiment;

FIG. 15A is a diagram illustrating the procedures of the signal pattern generating process and the delay measuring process according to the first embodiment;

FIG. 15B is a diagram illustrating the procedures of the signal pattern generating process and the delay measuring process according to the first embodiment;

FIG. 16A is a diagram illustrating an example FF delay library generated according to the first embodiment;

FIG. 16B is a diagram illustrating an example FF delay library generated according to the first embodiment;

FIG. 17 is a block diagram illustrating an example functional configuration of a delay library generation device according to a second embodiment;

FIG. 18 is an example flowchart illustrating the outline of procedures of a delay library generating process according to the second embodiment;

FIG. 19 is an example flowchart illustrating procedures of a true value table preparing process according to the second embodiment;

FIG. 20 is an example flowchart illustrating procedures of a true value table preparing process according to the second embodiment;

FIG. 21 is a diagram illustrating example cutting of a circuit loop according to the second embodiment;

FIG. 22 is a diagram illustrating an example stabilizing process (indefinite value correction) according to the second embodiment;

FIG. 23A is a diagram illustrating example procedures of simulation pattern and true value table preparation according to the second embodiment;

FIG. 23B is a diagram illustrating example procedures of simulation pattern and true value table preparation according to the second embodiment; and

FIG. 23C is a diagram illustrating example procedures of simulation pattern and true value table preparation according to the second embodiment.

### DESCRIPTION OF EMBODIMENTS

Embodiments will be described with reference to the accompanying drawings.

### [1] Explanation of First Embodiment

### [1-1] Configuration of Delay Library Generation Device according to First Embodiment

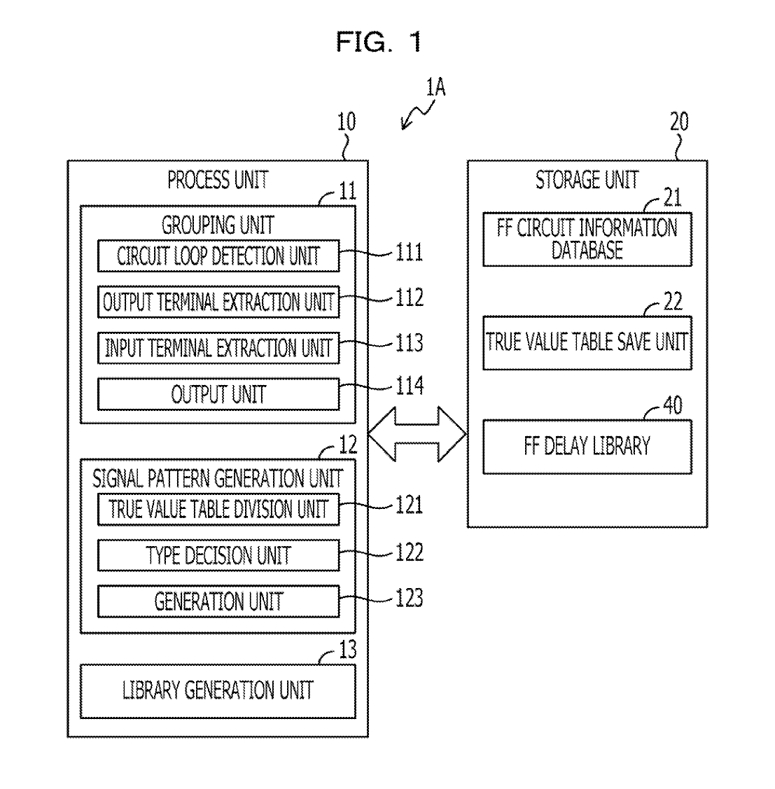

FIG. 1 is a block diagram illustrating an example functional configuration of a delay library generation device 1A according to the first embodiment.

The delay library generation device 1A illustrated in FIG. 1 is adapted to generate a delay library 40 of a sequential logic circuit (FF) and is configured using a computer. The delay library generation device 1A includes a process unit 10, a storage unit 20, and a man machine interface (not illustrated) which is operated by a user to input various information into the delay library generation device 1A. Incidentally, the process unit 10 is a CPU (Central Processing Unit) or the like. The storage unit 20 may be either an internal storage device such as, for example, a RAM (Random Access Memory), a ROM (Read Only Memory), an HDD (Hard Disk Drive), an SSD (Solid State Drive) or the like or an external storage device.

The process unit 10 executes a delay library generation program to function as a grouping unit 11, a signal pattern generation unit 12 and a library generation unit 13 which will be described later.

In addition, the storage unit 20 includes an FF circuit information database 21, a true value table save unit 20 and the FF delay library 40 which will be described later and appropriately stores various information that a user sets, the above described delay library generation program and the like.

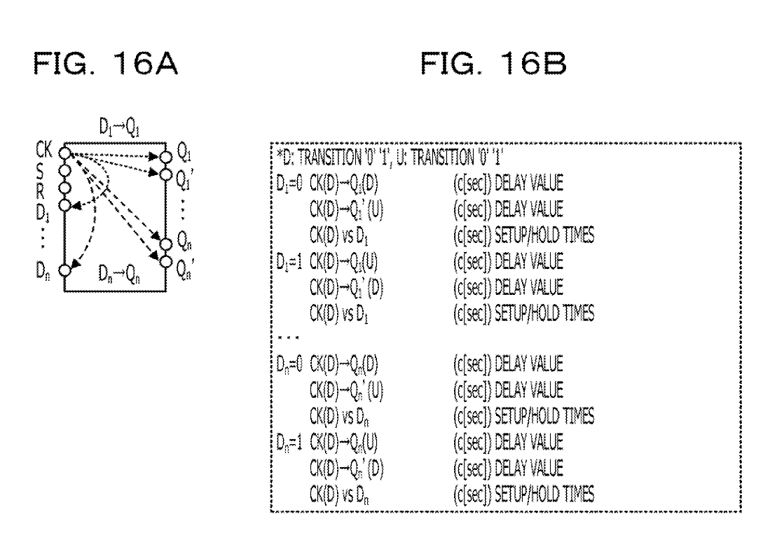

Incidentally, the FF delay library 40 is generated by the delay library generation device 1A based on later described functions, operations and holds characteristic information such as, for example, delay values, and setup time and hold times as timing constraints of an object FF as will be described later with reference to FIG. 16.

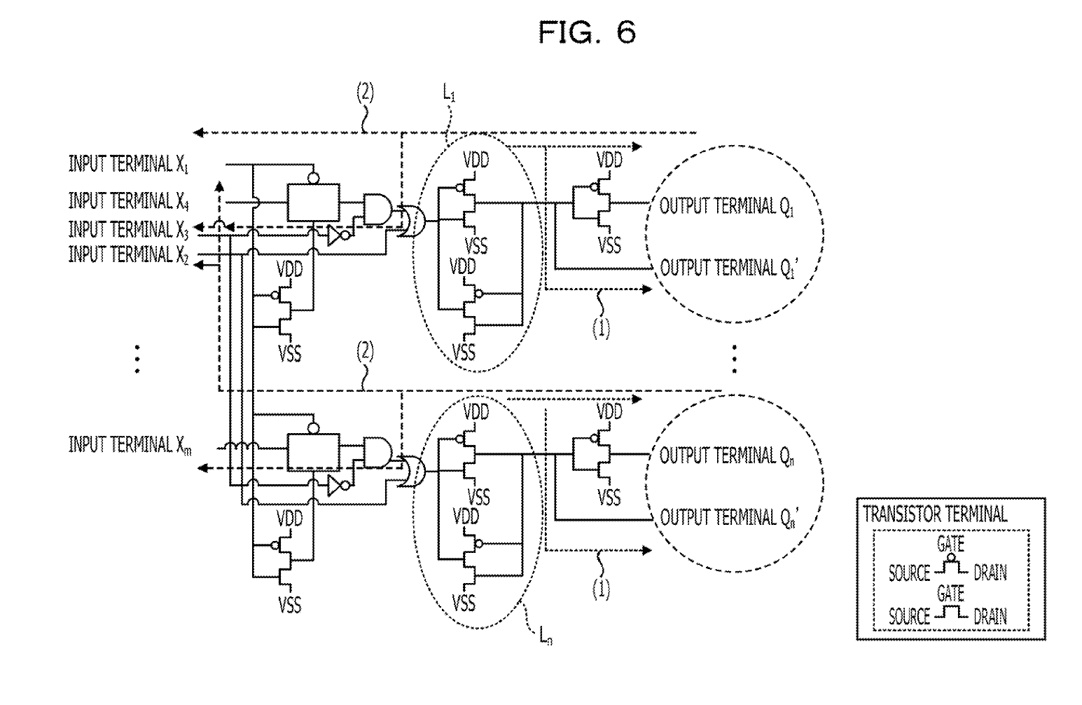

The FF circuit information database 21 is provided in advance by a designer or others and holds circuit information of an object FF for which the FF delay library 40 is to be generated such as, for example, detailed circuit information in an object FF as illustrated in FIG. 6. Hereinafter, the circuit information of the FF will be referred to as FF circuit information.

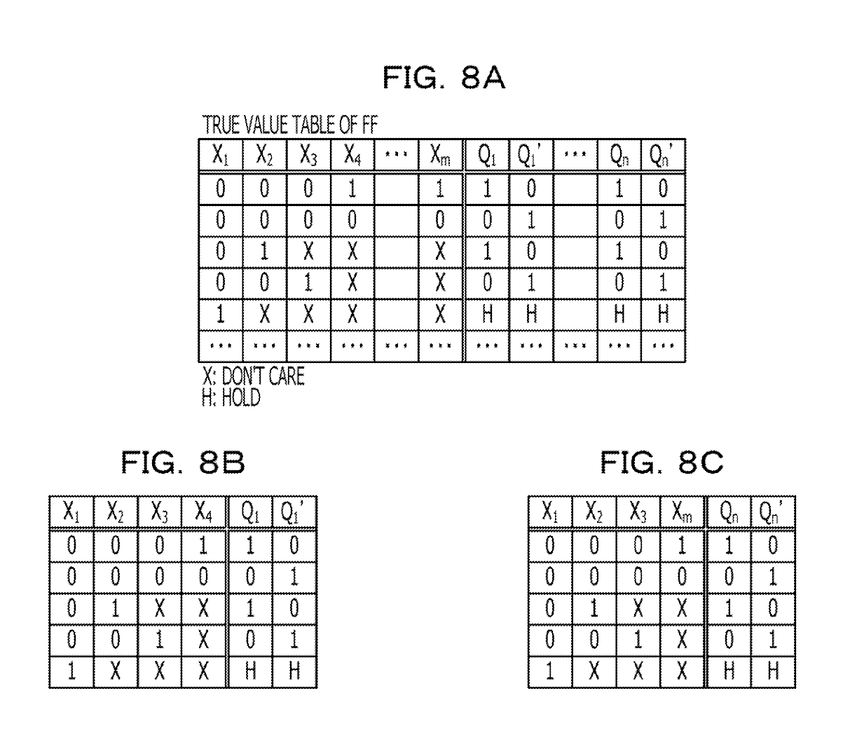

The true value table save unit 22 saves a true value table indicating a relation between a status value given to an input terminal of the object FF and a status value output from a corresponding output terminal when the above status value has been given. The true value table is as illustrated, for example, in FIG. 8A and is provided in advance by a designer or others and saved in the true value table save unit 22 in the first embodiment.

Identification of whether a terminal of an object FF is an input terminal or an output terminal is included in the above mentioned FF circuit information and true value table. The FF circuit information and true value table include terminal identification information Q₁, Q₁′, Q₂, Q₂′, . . . , and Qₙ, Qₙ′ that specify the respective output terminals and the respective output terminals are specified by the terminal identification information Q₁, Q₁′, Q₂, Q₂′, . . . , and Qₙ, Qₙ′. Incidentally, in the object FF, each output terminal is a pair of an output terminal and a reverse output terminal respectively specified by the terminal identification information Qᵢ and Qᵢ′ (i=1, 2, . . . , and n).

The FF circuit information and the true value table also include terminal identification information X₁, X₂, . . . , and Xₘ that may specify respective input terminals and the respective input terminals are specified by the terminal identification information X₁, X₂, . . . , and Xₘ. However, the FF circuit information and the true value table do not include information used to specify the type of each input terminal, that is, to which one of a clock terminal, a set terminal, a reset terminal and a data terminal each input terminal corresponds. That is, although a corresponding relation between an input terminal in the FF circuit information illustrated in FIG. 6 and an input terminal in the true value table of the object FF illustrated in FIG. 8A is recognized, no semantics are given to the input terminal information in the FF circuit information and the true value table and the type of each input terminal is not recognized. Therefore, in the delay library generation device 1A, determination and recognition of the type of each input terminal are performed by the later described signal pattern generation unit 12 (a type decision unit 122) in generation of the FF delay library 40.

Next, functions that the process unit 10 according to the first embodiment performs as the grouping unit 11, the signal pattern generation unit 12 and the library generation unit 13 will be described in detail.

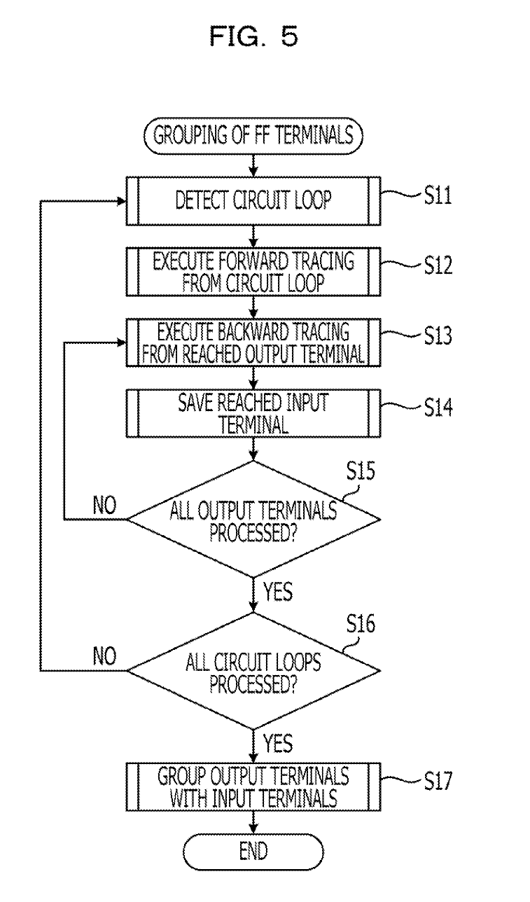

The grouping unit 11 groups an output terminal (a paired output terminal) of the object FF with input terminals of the object FF that influence the output terminal (combines the terminals with one another to form groups) based on the FF circuit information of the object FF. The grouping unit 11 functions as a circuit loop detection unit 111, an output terminal extraction unit 112, an input terminal extraction unit 113 and an output unit 114 which will be described later. Specific functions and operations of the grouping unit 11 including the circuit loop detection unit 111, the output terminal extraction unit 112, the input terminal extraction unit 113 and the output unit 114 will be described later with reference to FIG. 5 and FIG. 6.

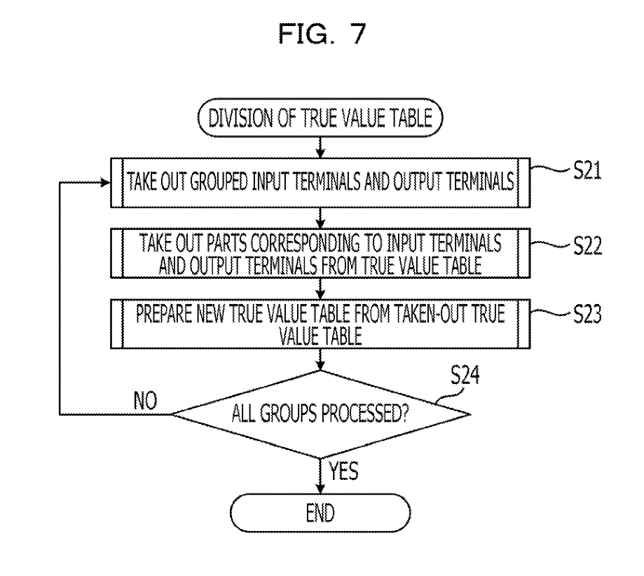

The signal pattern generation unit 12 generates a signal pattern for each input terminal of the object FF per group based on the groups obtained by the grouping unit 11 and the true value table of the object FF saved in the true value table save unit 22. The signal pattern is a simulation pattern for preparation of a delay library and it may be possible to prepare the delay library 40 of the FF by setting the signal pattern to the input terminal concerned to measure delay information, as described later. The signal pattern generation unit 12 has functions as a true value table division unit 121, a type decision unit 122 and a generation unit 123 which will be described later. Specific functions and operations of the signal pattern generation unit 12 including the true value table division unit 121, the type decision unit 122 and the generation unit 123 will be described later with reference to FIGS. 7 to 15.

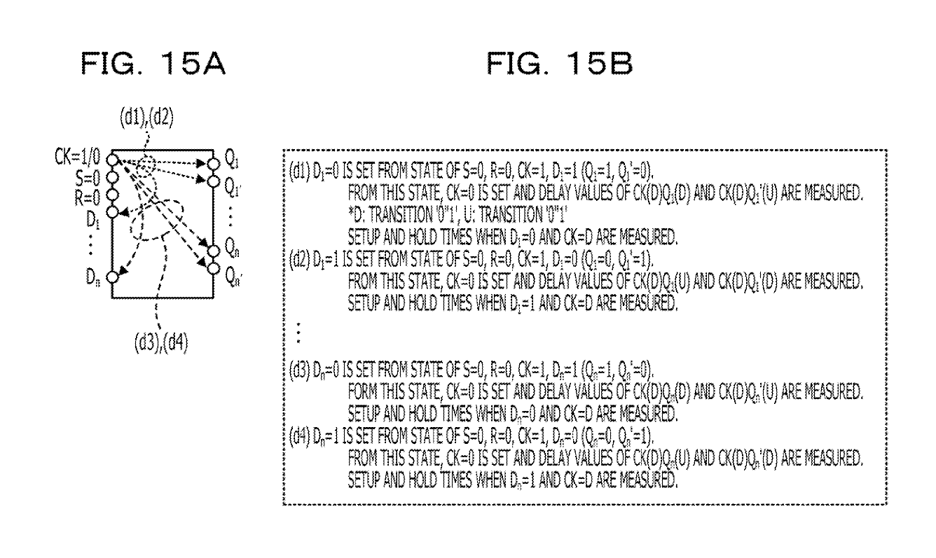

The library generation unit 13 measures the delay information per group based on the signal pattern which has been generated per group by the signal pattern generation unit 12, and the library generation unit 13 generates the delay library 40 of the object FF. Specific functions and operations of the library generation unit 13 will be described later with reference to FIG. 15 and FIG. 16.

Next, the functions of the circuit loop detection unit 111, the output terminal extraction unit 112, the input terminal extraction unit 113 and the output unit 114 included in the grouping unit 11 will be described.

The circuit loop detection unit 111 detects a circuit loop that keeps a signal output or a status of the object FF from the FF circuit information of the object FF. In general, in the FF, two inverters are connected with each other to form a circuit loop that holds a signal or a status. Therefore, the circuit loop detection unit 111 traces the object FF while marking each circuit of the object FF with reference to the FF circuit information and is allowed to detect the circuit loop when it returns to a position which has been marked before.

The output terminal extraction unit 112 performs forward tracing starting from the circuit loop that the circuit loop detection unit 111 has detected to extract an output terminal of the object FF which is connected with the circuit loop from the FF circuit information of the object FF. Forward tracing performed by the output terminal extraction unit 112 will be described later with reference to operation S12 in FIG. 5 and FIG. 6.

The input terminal extraction unit 113 performs backward tracing starting from the output terminal that the output terminal extraction unit 112 has extracted to extract an input terminal that influences the output terminal from the FF circuit information of the object FF. Backward tracing performed by the input terminal extraction unit 113 will be described later with reference to operation S13 in FIG. 5 and FIG. 6.

The output unit 114 groups the output terminal that the output terminal extraction unit 112 has extracted with the input terminals that the input terminal extraction unit 113 has extracted to output them as one group per output terminal. Specific examples of respective groups that the output unit 114 outputs will be described later with reference to FIG. 6.

The functions of the true value table division unit 121, the type decision unit 122 and the generation unit 123 included in the signal pattern generation unit 12 will be described.

The true value table division unit 121 divides the true value table of the object FF saved in the true value table save unit 22 into several true value tables per group based on the groups obtained by the grouping unit 11. Specific functions and operations of the true value table division unit 121 will be described later with reference to FIG. 7 and FIG. 8.

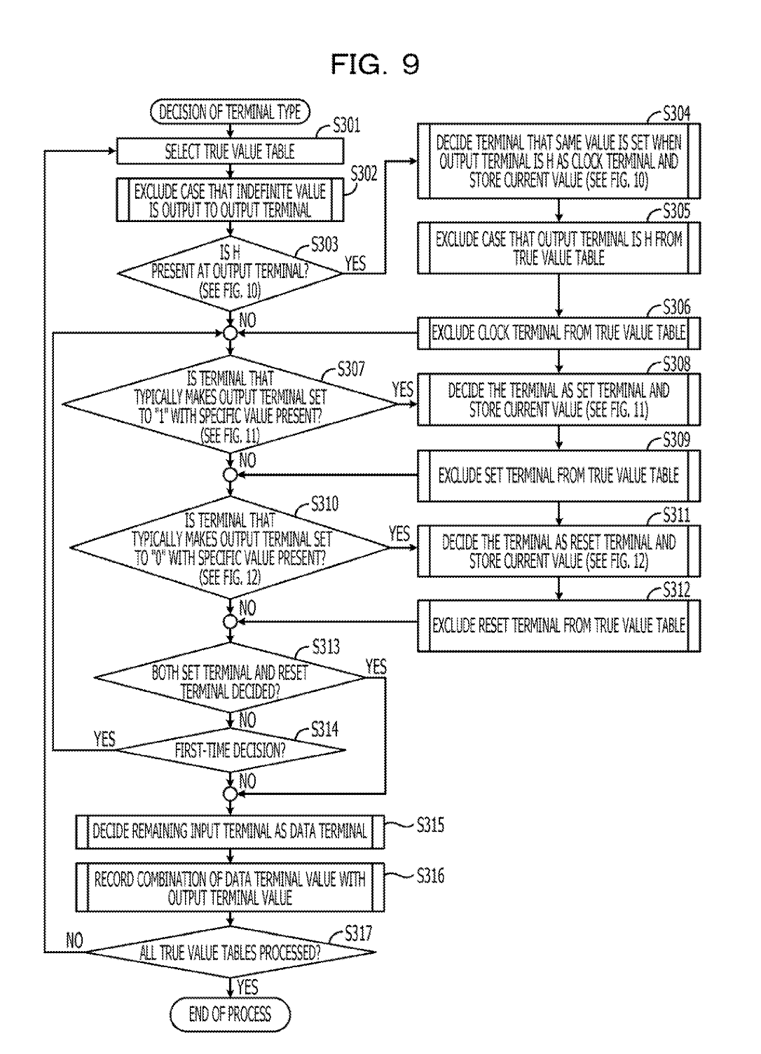

The type decision unit 122 decides the type of each input terminal per group based on each divided true value table divided by the true value table division unit 121. Basic deciding functions of the type decision unit 122 are as described in the following items (a1) to (a4). Specific functions and operations of the type decision unit 122 will be described later with reference to FIG. 9 to FIG. 13.

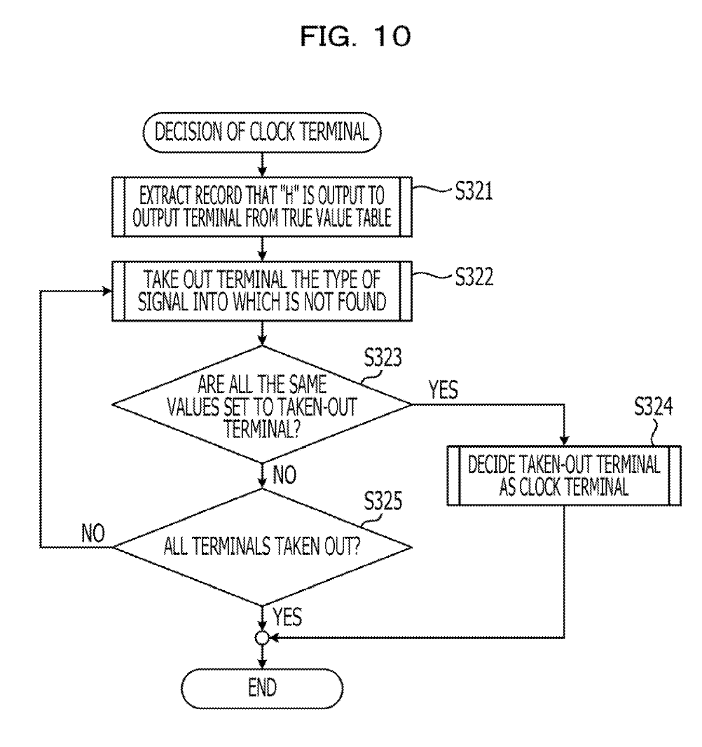

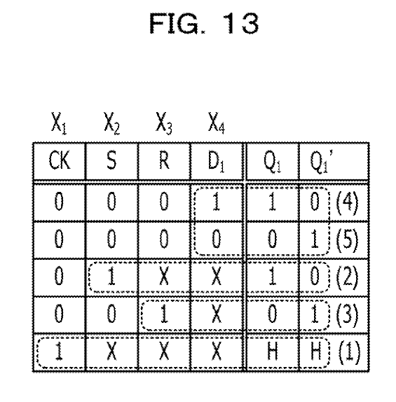

(a1) The type decision unit 122 extracts a record which is a one-line element in the true value table in which “H (hold)” is set as a status of an output terminal in the true value table and decides an input terminal to which the same status value “1” or “0” is set in all the extracted records as a clock terminal. The clock terminal decision will be described later with reference to FIG. 9, FIG. 10 and FIG. 13.

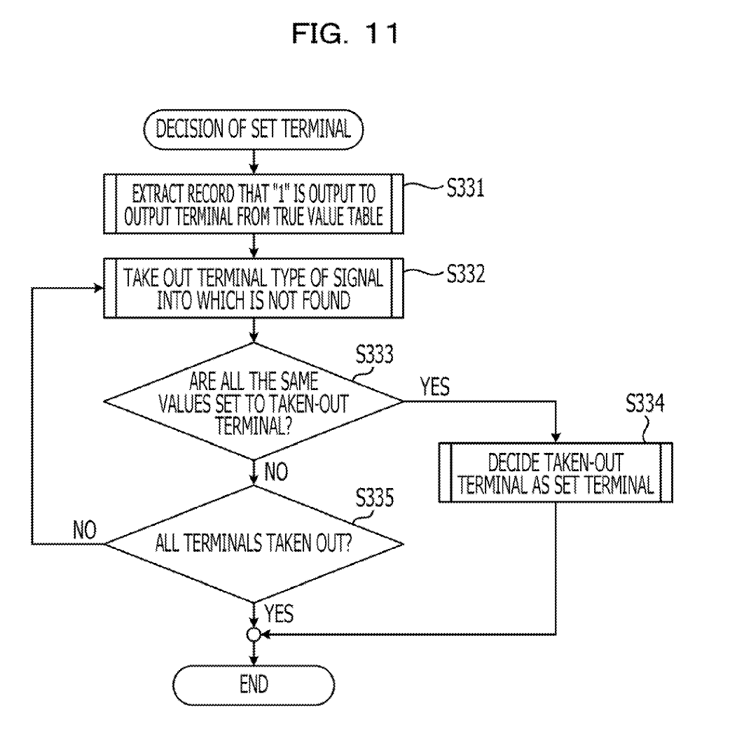

(a2) The type decision unit 122 extracts a record in which “1” is set as the status of an output terminal and decides an input terminal to which the same status value “1” or “0” is set in all the extracted records as a set terminal in the true value table from which the record in the true value table involving the clock terminal and the input signal which has been decided as the clock terminal have been excluded. The set terminal decision will be described later with reference to FIG. 9, FIG. 11 and FIG. 13.

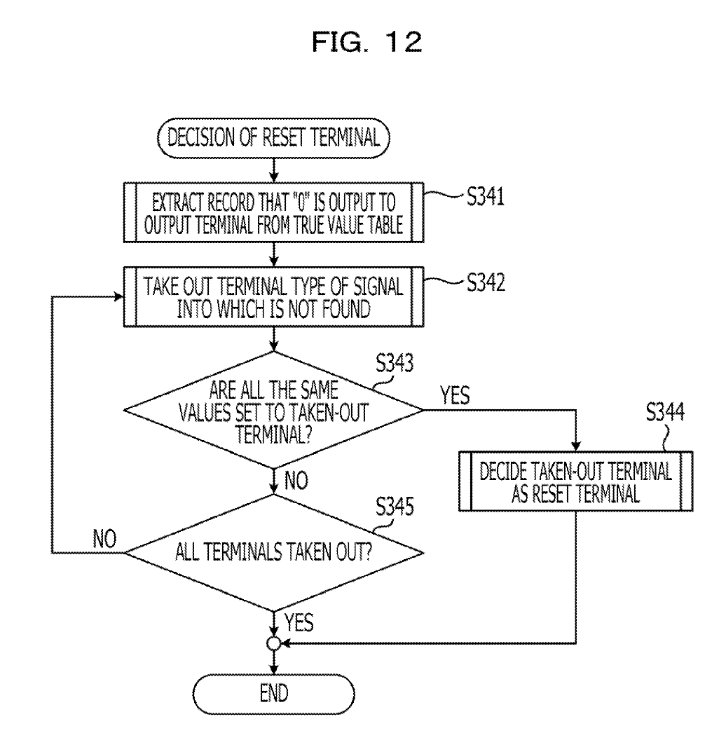

(a3) The type decision unit 122 extracts a record in which “0” is set as a status of an output terminal, and the type decision unit 122 decides an input terminal to which the same status value “1” or “0” is set in all the extracted records as a reset terminal in the true value table from which the records in the true value table involving the clock terminal, the set terminal and the input terminals which have been decided as the clock terminal and the set terminal have been excluded. The reset terminal decision will be described later with reference to FIG. 9, FIG. 12 and FIG. 13.

(a4) The type decision unit 122 decides an input terminal which remains undecided after making the above decisions described in the items (a1) to (a3) as a data terminal. The data terminal decision will be described later with reference to FIG. 9 and FIG. 13.

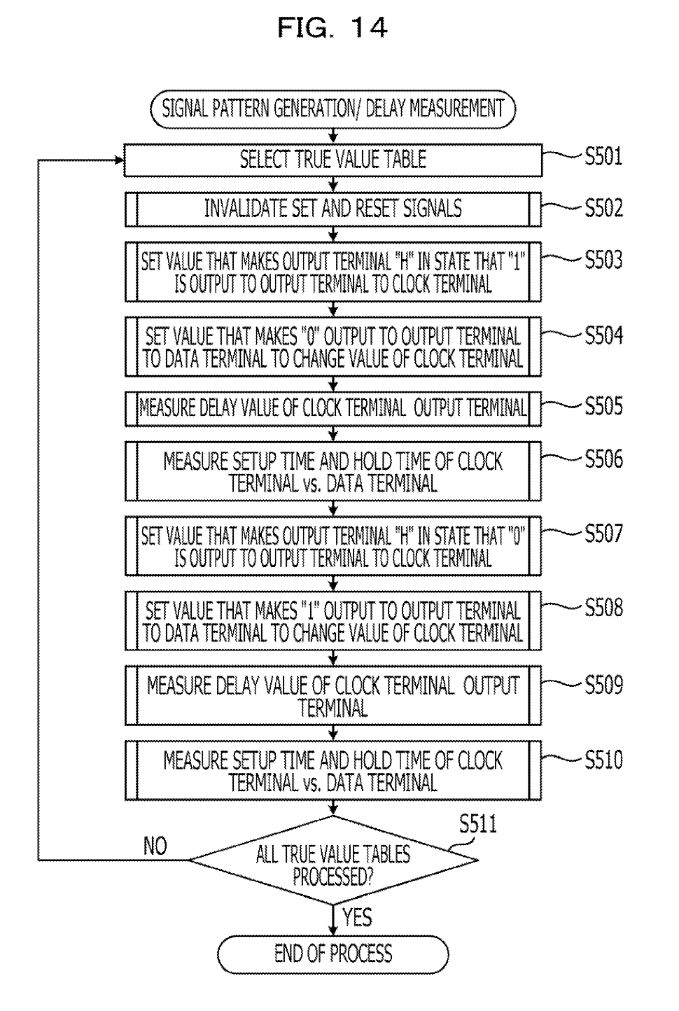

The generation unit 123 generates a signal pattern to be set for an input terminal of the object FF, that is, a simulation pattern for preparation of the delay library per group based on the type of each input terminal that the type decision unit 122 has decided. The basic generating function of the generation unit 123 and the basic generating function that the library generation unit 13 performs based on the signal pattern that the generation unit 123 has generated are as described in the following items (b1) and (b2). Specific functions and operations of the generation unit 123 and the library generation unit 13 will be described later with reference to FIG. 14 to FIG. 16.

(b1) The generation unit 123 generates a first signal pattern for an input terminal that makes the status of an output terminal transit from “1” to “0” per group in accordance with a result of decision made by the type decision unit 122. In the above mentioned situation, the library generation unit 13 measures a delay value from the clock signal to the corresponding output terminal and a setup time and a hold time of the data terminal taken for the clock terminal when the status of the output terminal undergoes transition from “1” to “0” as delay information by simulation based on the first signal pattern. That is, the library generation unit 13 measures delay information obtained upon signal falling at the output terminal by simulation and records it in the storage unit 20 to generate the delay library 40 of the object FF.

(b2) The generation unit 123 generates a second signal pattern for the input terminal that makes the status of the output terminal transit from “0” to “1” in the reverse order of the operation in the item (b1) per group in accordance with a result of decision made by the type decision unit 122. In the above mentioned situation, the library generation unit 13 measures a delay value from the clock signal to each output terminal (a delay time from signal transition at the clock signal to transition of an output signal at each output terminal) and a setup time and a hold time of the data terminal to the clock terminal when the status of the output terminal undergoes transition from “0” to “1” based on the second signal pattern as delay information by simulation. That is, the library generation unit 13 measures delay information obtained upon signal rising at the output terminal by simulation and records it in the storage unit 20 to generate the delay library 40 of the object FF.

### [1-2] Delay Analysis of LSI Circuit

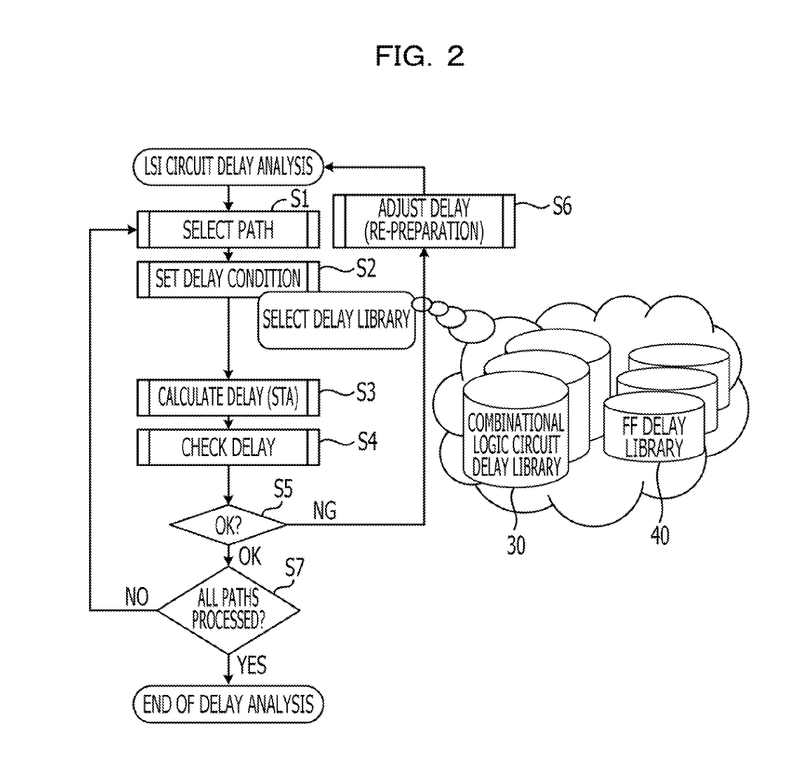

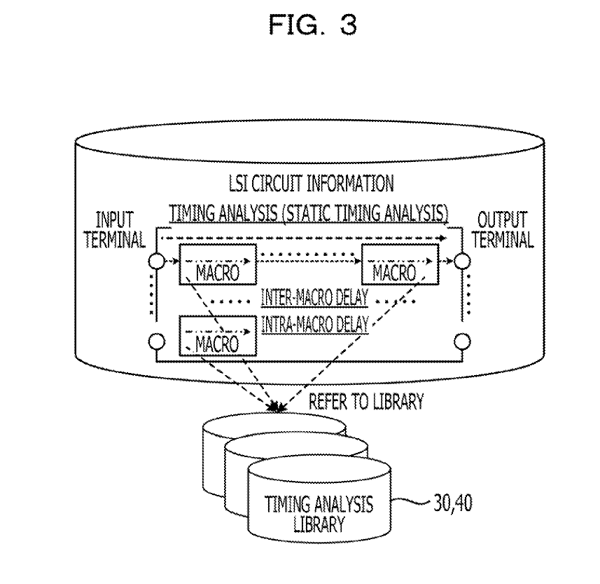

Here, procedures of a process of analyzing a delay of an LSI circuit performed using the FF delay library 40 which has been generated by the delay library generation device 1A will be described with reference to FIG. 2 and FIG. 3 prior to explanation of the operation of the delay library generation device 1A according to the first embodiment. FIG. 2 is an example flowchart (operation S1 to operation S7) illustrating the procedures of the delay analyzing process and FIG. 3 a diagram illustrating example delay calculation.

As illustrated in FIG. 2, a path of the LSI circuit is selected at first in analysis of a delay of the LSI circuit (operation S1), the delay analysis library of a macro on the selected path is selected to set delay conditions (operation S2). In the above mentioned case, a combinational logic circuit delay library 30 corresponding to the macro is selected as the delay library for delay analysis when the macro is a combinational logic circuit. When the macro is an FF, the FF delay library 40 corresponding to the macro is selected as the delay library for delay analysis. A MAX condition and a min condition for calculation of a maximum value (MAX) and a minimum value (min) of the delay value are set as the delay conditions.

Then, a delay value of the path selected at operation S1 is calculated based on the delay conditions set at operation S2 and the delay library 30 or 40 also selected at operation S2 (operation S3). The delay value is calculated by STA using the delay library 30 or 40 as described above. That is, a propagation time of a signal from the input terminal to the output terminal of the object path is calculated in accordance with the MAX condition and the min condition as illustrated in FIG. 3. In the above mentioned case, macros on the object path and connecting relations among them are read from the circuit information of the LSI circuit, and an inter-macro delay value is calculated based on the read information and an intra-macro delay value of each macro is read with reference to the delay library 30 or 40 of each macro on the object path. The propagation time of the signal from the input terminal to the output terminal of the object path is calculated by adding the inter-micro delay value so calculated as described above to the intra-micro delay value so read as described above. The delay libraries 30 and 40 are present for each macro and the intra-micro delay value of each macro is saved in each of the delay libraries 30 and 40.

The delay of the object path selected at operation S1 is checked based on the calculated propagation time (operation S4). When a problem is found in the calculated propagation time (an NG route at operation S5), the propagation time is again calculated for delay adjustment (operation S6) and delay analysis is again executed. When no problem is found in the calculated propagation time (an OK route at operation S5), whether the process for all the paths of the LSI circuit is completed is decided (operation S7). If the process for all the paths of the LSI circuit is not completed, the process will return to operation S1. If the process for all the paths of the LSI circuit is completed, execution of the delay analyzing process will be terminated.

### [1-3] Operation of Delay Library Generation Device according to First Embodiment

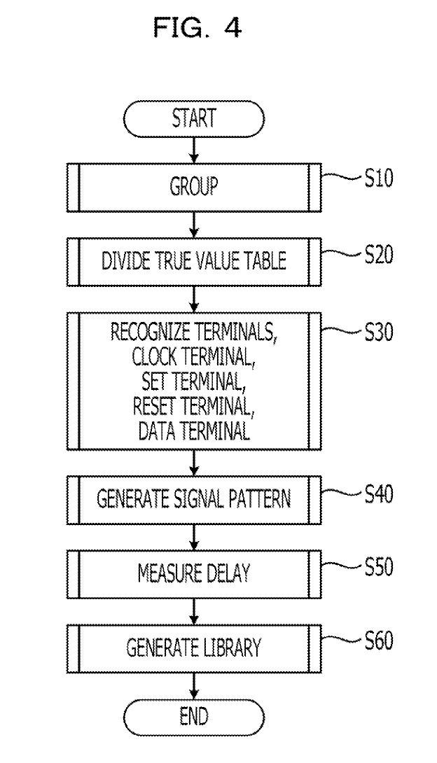

Next, the functions and operations of the delay library generation device 1A so configured according to the first embodiment will be described with reference to FIG. 4 to FIG. 16. The delay library generation device 1A according to the first embodiment is of the type that generates the FF delay library 40 used in execution of the delay analyzing process which has been described with reference to FIG. 2 and FIG. 3. In the following, details of the procedures of a process of generating the FF delay library 40 will be described.

### [1-3-1] Outline of Procedures ofr Delay Library Generating Process

The outline of the procedures for the delay library generating process executed by the delay library generation device 1A according to the first embodiment will be described in accordance with a flowchart (operation S10 to operation S60) illustrated in FIG. 4.

First, the grouping unit 11 groups an output terminal of an object FF with input terminals of the object FF that influence the output terminal concerned based on the FF circuit information of the object FF (operation S10: the grouping operation). That is, the grouping unit 11 detects a circuit loop of the object FF and then performs forward tracing starting from the detected circuit loop to extract the output terminal of the object FF. Then, the grouping unit 11 performs backward tracing starting from the extracted output terminal to extract the input terminals of the object FF that influence the output terminal. As a result, the output terminal is grouped with the input terminals that influence the output terminal concerned. The procedures of the grouping process performed at operation S10 will be described in detail with reference to FIG. 5 and FIG. 6.

Then, the signal pattern generation unit 12 generates a signal pattern for each input terminal of the object FF, that is, a simulation pattern for preparation of the delay library per group based on the groups obtained at operation S10 and the true value table of the object FF saved in the save unit 22 (operation S20 to operation S40; the signal pattern generating operation).

That is, the true value table division unit 121 of the signal pattern generation unit 12 divides the true value table of the object FF saved in the save unit 22 into several true value tables for the respective groups based on the groups obtained at operation S10 (operation S20). The type decision unit 122 of the signal pattern generation unit 12 decides and recognizes to which one of the clock terminal, the set terminal, the reset terminal and the data terminal the type of the input terminal corresponds per group based on each divided true value table divided at operation S20 (operation S30). The generation unit 123 of the signal pattern generation unit 12 generates a signal pattern for the input terminal of the object FF per group based on the type of the input terminal decided at operation S30 (operation S40). Incidentally, procedures of the true value table dividing process at operation S20 will be described in detail with reference to FIG. 7 and FIG. 8 and procedures of the terminal type deciding process at operation S30 will be described in detail with reference to FIG. 9 to FIG. 13.

Then, the library generation unit 13 measures the delay value, the setup time and the hold time of the object FF per group as delay information based on the signal patterns generated per group at operation S40 (operation S50). And, the delay library 40 of the object FF is generated from a result of the decision and stored in the storage unit 20 (operation S60; the library generating operation). Incidentally, the procedures of the signal pattern generating process at operation S40, the procedures of the delay measuring process at operation S50 and the FF delay library 40 generated at operation S60 will be described in detail with reference to FIG. 14 to FIG. 16.

### [1-3-2] Procedures of Grouping Process

Next, the procedures of the grouping process executed by the grouping unit 11 at operation S10 in FIG. 4 will be described in accordance with a flowchart (operation S11 to operation S17) with reference to FIG. 6. FIG. 6 is a diagram illustrating the procedures of the grouping process according to the first embodiment and illustrates a specific circuit example of the object FF for which the delay library 40 is generated. Information on a circuit as illustrated in FIG. 6 is held in the database 21 as the FF circuit information. Although it may be possible to identify to which one of the input and output signals the terminal of the object FF corresponds as described above, the type of each input terminal is not specified in the above FF circuit information. In the FF circuit information illustrated in FIG. 6, the respective output terminals are specified by the terminal identification information Q₁, Q₁′, Q₂, Q₂′, . . . , and Qₙ, Qₙ′ and the respective input terminals are specified by the terminal identification information X₁, X₂, X₃, X₄, . . . , and Xₘ.

First, the circuit loop detection unit 111 detects a circuit loop Lᵢ (see FIG. 6; i=1, 2, . . . , and n) that holds the status in the object FF from the FF circuit information of the object FF when the grouping unit 11 groups the terminals of the object FF with one another (operation S11). The circuit loop detection unit 111 traces while marking the circuit of the object FF with reference to the FF circuit information as described above, and the circuit loop detection unit 111 detects the circuit loop Lᵢ when it has returned to the marked position.

When the circuit loop Lᵢ is detected at operation S11, the output terminal extraction unit 112 performs forward tracing starting from the circuit loop Lᵢ (operation S12). Then, the output terminals Qi and Qi′ at which the output terminal extraction unit 112 has arrived by forward tracing are extracted from the FF circuit information of the object FF as output terminals connected with the circuit loop Lᵢ. Incidentally, forward tracing is executed in a direction directing from a gate to a drain or in a direction directing from a source to the drain (see an arrow (1)) as illustrated in FIG. 6 as for a transistor terminal.

Then, backward tracing is performed by the input terminal extraction unit 113 starting from the output terminals Qᵢ and Qᵢ′ so arrived at operation S12 (operation S13). Input terminals that influence the output terminals Qᵢ and Qᵢ′ are extracted from the FF circuit information of the object FF as the input terminals so arrived by backward tracing and information on the extracted input terminals is stored in the storage unit 20 in correspondence with the output terminals Qᵢ and Qᵢ′(operation S14). Incidentally, backward tracing is executed in a direction directing from the drain to the gate or in a direction directing from the drain to the source (see an arrow (2)) as illustrated in FIG. 6 as for the transistor terminal. In the example illustrated in FIG. 6, when backward tracing is performed starting from the output terminals Q₁ and Q₁′, the input terminal extraction unit 113 arrives at the input terminals X₁, X₂, X₃ and X₄. While when backward tracing is performed starting from the output terminals Qₙ and Qₙ′, it arrives at the input terminals X₁, X₂, X₃ and Xₘ.

The processes at operation S13 and operation S14 are repetitively executed until these processes are executed on all the output terminals extracted at operation S12 (a NO route at operation S15). The grouping unit 11 that has completed execution of the processes on all the output terminals extracted at operation S12 (a YES route at operation S15) decides whether execution of the processes on all the circuit loops in the object FF has been completed (operation S16). When execution of the processes on all the circuit loops in the object FF is not yet completed (a NO route at operation S16), the execution of the processes returns to the process at operation S11.

When execution of the processes on all the circuit loops in the object FF is completed (a YES route at operation S16), the output unit 114 groups the output terminals extracted at operation S12 with the input terminals extracted at operation S13 based on the information saved in the storage unit 20 at operation S14, and the output unit 114 outputs the grouped terminals to the storage unit 20 to be stored in it (operation S17). In the example illustrated in FIG. 6, the output terminals Q₁ and Q₁′ are grouped with the input terminals X₁, X₂, X₃ and X₄ as one group G₁, and the output terminals Qₙ and Qₙ′ are grouped with the input terminals X₁, X₂, X₃ and Xₘ as another group G_{N}.

A range that a signal for the input terminal belonging to each group Gⱼ influences is limited to the output terminals belonging to each group Gⱼ (j=2, . . . , and N) obtained by grouping the terminals with one another as described above. Accordingly, the amount of calculation for generation of the FF delay library 40 may be preferably reduced by generating a signal pattern which is a combination of signals for the input terminals per group as compared with a case that combinations of signals for all the input terminals of the object FF are simultaneously considered.

### [1-3-3] Procedures of True Value Table Dividing Process

Next, the procedures of the true value table dividing process executed by the true value table division unit 121 at operation S20 in FIG. 4 will be described in accordance with a flowchart (operation S21 to operation S24) illustrated in FIG. 7 with reference to FIG. 8A to FIG. 8C. Incidentally, FIG. 8A illustrates an example true value table (a pre-division table) of the object FF which is saved in the true value table save unit 22 as described above, that is, an example true value table of the object FF illustrated in FIG. 6. FIG. 8B and FIG. 8C respectively illustrate example new true value tables (post-division tables) obtained by dividing the true value table of the object FF illustrated in FIG. 8A in the following procedures. In FIG. 8A to FIG. 8C, “X” denotes “don't care” (an indefinite value) and “H” denotes “hold”.

Although the true value tables (pre-division table and post-division tables) in FIG. 8A to FIG. 8C may allow to identify to which one of the input and output terminals a terminal of the object FF corresponds, the type of each input terminal is not specified in the true value tables. The true value tables illustrated in FIG. 8A to FIG. 8C correspond to the object FF in FIG. 6, respectively. And, the respective output terminals in these true value tables are also specified by the terminal identification information Q₁, Q₁′, Q₂, Q₂′, . . . , and Qₙ, Qₙ′, and the respective input terminals in these true value tables are also specified by the terminal identification information X₁, X₂, X₃, X₄, . . . , and Xₘ as in the FF circuit information.

Each group Gⱼ defines an influence range that a signal input into an input terminal influences an output terminal as described above. The true value division unit 121 divides a true value table of the object FF, for example, as illustrated in FIG. 8A into several tables for respective groups based on the information relating to each group Gⱼ in the procedures illustrated in FIG. 7.

The identification information of the input terminals and the output terminals belonging to each group Gj is taken out with respect to each group Gᵢ (operation S21). Then, parts corresponding to the input terminals and the output terminals are taken out of the true value table in the true value table save unit 22 based on the taken-out identification information of the input terminals and the output terminals (operation S22). A new true value table of the group Gⱼ is generated by combining the taken-out parts of the true value table Gⱼ with one another and is saved in the storage unit 20 (operation S23). In the above mentioned case, the new true value table may be saved either in the true value table save unit 22 or in a storage area which is different from the true value save unit 22 in the storage unit 20.

The processes at operation S21 to operation S23 are repetitively executed until these processes are executed on all the groups Gⱼ (a NO route at operation S24). The true value table division unit 121 that has completed execution of the processes on all the groups Gⱼ (a YES route at operation S24) terminates execution of the true value table dividing process.

For example, the true value table illustrated in FIG. 8B which has been divided from the true value table in FIG. 8A corresponds to the above group G₁, and the true value table illustrated in FIG. 8B is generated by extracting parts corresponding to the input terminals X₁, X₂, X₃ and X₄ and the output terminals Q₁ and Q₁′ belonging to the group G₁ from the true value table in FIG. 8A. Likewise, the true value table illustrated in FIG. 8C which has been divided from the true value table in FIG. 8A corresponds to the above mentioned group G_{N}, and the true value table illustrated in FIG. 8C is generated by extracting parts corresponding to the input terminals X₁, X₂, X₃ and Xₘ and the output terminals Qₙ and Qₙ′ belonging to the group G_{N} from the true value table in FIG. 8A.

### [1-3-4] Procedures of Terminal Type Deciding Process

Next, the procedures of the terminal type deciding process executed by the terminal type decision unit 122 at operation S30 in FIG. 4 will be described in accordance with a flowchart (operation S301 to operation S317) illustrated in FIG. 9 with reference to the FIG. 8B and FIG. 13. Incidentally, FIG. 13 is a diagram illustrating the procedures of the terminal type deciding process according to the first embodiment and specifically illustrating the types of the input terminals which are decided based on the true value table for the group G₁ illustrated in FIG. 8B.

First, one true value table is selected from among the true value tables so divided as mentioned above (operation S301) and a record corresponding to a case that an indefinite value X is output to the output terminal is excluded from the selected true value table (operation S302). Incidentally, the case that the indefinite value X is output to the output terminal is not illustrated in the examples of the true value tables in the FIG. 8A to FIG. 8C.

Then, the terminal type decision unit 122 decides whether a record in which “H (hold)” is set as the status of the output terminal is present in the selected true value table (operation S303). When the true value table is for an FF, since the record in which “H” is set as the status of the output terminal is typically present, the terminal type decision unit 122 proceeds to the process at operation S304 after execution of the process at operation S303 (a YES route at operation S303).

At operation S304, when a plurality of records in which “H” is set as the status of each of the output terminals are present, an input terminal to which the same status value “1” or “0” is set in the plurality of records is decided as the clock signal CK and the current status value obtained when it has been decided as the clock signal CK is stored as an operation value. When the number of records in which “H” is set as the status of each of the output terminals is one, the status value “1” or “0” is set as the status value of one input terminal and the indefinite values X are set as the status values of the other input terminals in the above record. Therefore, when the number of records in which “H” is set is one, the above one input terminal is decided as the clock terminal CK and the current status value obtained when the input terminal has been decided as the clock terminal CK is stored as an operation value. For example, in the true value table of the group G₁ illustrated in FIG. 8B, only one record (1) in which “H's are set as the statuses of the output terminals is extracted as illustrated in FIG. 13. Since the number of records in which “H” is set is one, the input terminal X₁ to which “1” is set is as the status value in the record (1) is decided as the clock terminal CK in the example in FIG. 13.

The details of the process at operation S304, that is, the procedures of the clock terminal deciding process according to the first embodiment will be described in accordance with a flowchart (operation S321 to operation S325) in FIG. 10. The type decision unit 122 extracts a record in which “H” is set as the status of each of the output terminals from the selected true value table (operation S321). The type decision unit 122 takes an input terminal the type of signal into which is not found, that is, one input terminal the type of which is not yet decided out of the extracted record (operation S322).

Then, whether the same value “1” or “0” is to the input terminal which has been taken out at operation S322 as the status values is decided (operation S323). When the same value “1” or “0” is set to the input terminal which has been taken out at operation S322 (a YES route at operation S323), the type decision unit 122 decides the input terminal which has been taken out at operation S322 as the clock terminal CK, stores the value “1” or “0” which has been set to the input terminal when it has been decided as the clock signal CK (operation S324), and terminates execution of the clock terminal deciding process.

On the other hand, when the same value “1” or “0” is not set to the input terminal taken out at operation S322 as the status values (a NO route at operation S323), the type decision unit 122 decides whether all the input terminals the types of signals to which are not found have been taken out of the record so extracted at operation S321 (operation S325). When all the input terminals the types of which are not found are not yet taken out (a NO route at operation S325), the type decision unit 122 returns to the process at operation S322. When all the input terminals the types of which are not found have been taken out (a YES route at operation S325), the type decision unit 122 terminates execution of the clock terminal deciding process.

After the decision of the clock terminal CK, the type decision unit 122 excludes the record (for example, the record (1) in FIG. 13) in which “H” is set as the status of each output terminal from the true value table (operation S305), and the type decision unit 122 excludes the clock terminal CK, that is, the input terminal X₁ from the true value table (operation S306). Owing to execution of the above excluding process, the record involving the clock terminal CK and the clock terminal CK are excluded from the true value table. After execution of the excluding process has been completed or when it has been decided that a record in which “H” is set as the status of each output terminal is not present (a NO route at operation S303), the type decision unit 122 proceeds to the process at operation S307.

Presence/absence of an input terminal for which the status of its corresponding output terminal is typically set to “1” when the input terminal is set to a specific value “1” or “0” in the true value table from which the record involving the clock terminal CK and the input terminal that has been decided as the clock terminal CK are excluded is decided at operation S307. When the above mentioned input terminal is present (a YES route at operation S307), the input terminal is decided as the set terminal S and the current status value obtained when the input terminal has been decided as the set terminal S is stored as an operation value (operation S308).

Next, details of the processes at operation S307 and operation S308, that is, the procedures of the set terminal deciding process according to the first embodiment will be described in accordance with a flowchart (operation S331 to operation S335) illustrated in FIG. 11. The type decision unit 122 extracts a record in which “1” is set as the status of an output terminal from the true vale table from which the record involving the clock terminal CK and the input terminal which has been decided as the clock terminal CK are excluded (operation S331). The type decision unit 122 takes one input terminal the type of signal into which is not found, that is, the type of which is not yet specified out of the record extracted at operation S331 (operation S332).

Then, whether the same value “1” or “0” is set as the status values of the input terminal taken out at operation S322 is decided (operation S333). When the same value “1” or “0” is set as the status values of the input terminal taken out at operation S332 (a YES route at operation S333), the type decision unit 122 decides the input terminal taken out at operation S332 as the set terminal S, stores the value “1” or “0” which is currently set to the input terminal so decided as the set terminal S (operation S334) and terminates execution of the set terminal deciding process.

On the other hand, when the same value “1” or “0” is not set as the status values of the input terminal taken out at operation S332 (a NO route at operation S333), the type decision unit 122 decides whether all input terminals the types of signals into which are not found have been taken out of the record extracted at operation S331 (operation S335). When all the input terminals the types of which are not found are not yet taken out (a NO route at operation S335), the type decision unit 122 returns to the process at operation S332. When all the input terminals the types of which are not found have been taken out (a YES route at operation S335), the type decision unit 122 terminates execution of the set terminal deciding process.

The record (1) and the input terminal X₁ (the clock terminal (CK) are excluded as illustrated in FIG. 13, for example, in the true value table of the group G₁ in FIG. 8B. In the true value table from which the record (1) and the input terminal X₁ have been excluded, when the status values of the input terminals X₂, X₃ and X₄ are respectively set to “0”, “0” and “1”, the status value of the output terminal Q₁ is set to “1” in the record (4). On the other hand, in the record (2), when the status value of the input terminal X₂ is to “1” and the status values of the input terminals X₃ and X₄ other than the input terminal X₂ are set to indefinite values X, the status value of the output terminal Q₁ is set to “1”. Therefore, it is decided that when the status value of the input terminal X₂ is set to the specific value “1”, the status value of the output terminal Q₁ is typically set to “1” based on the record (2). Thus, the record (2) in which “1” is set as the status value of the output terminal Q₁ for the status value “1” of the input terminal X₂ is extracted. Then, the input terminal X₂ to which “1” is set as the status value is decided as the set terminal S in the record (2).

After decision of the set terminal S, the type decision unit 122 excludes the set terminal S, that is, the input terminal X₂ from the true value table (operation S309). After execution of an excluding process as described above has been terminated or when it has been decided that an input terminal for which the status of the corresponding output terminal is typically set to “1” when it is set to the specific value “1” or “0” is not present (a NO route at operation S307), the type decision unit 122 proceeds to the process at operation S310.

Presence/absence of an input terminal for which the status of the corresponding output terminal is typically set to “0” when it is set to a specific value “1” or “0” in each true value table from which the records involving the clock terminal CK and the set terminal S and the input terminals which have been decided as the clock terminal CK and the set terminal S are excluded is decided at operation S310. When an input terminal as described above is present (a YES route at operation S310), the input terminal is decided as the reset terminal R and the current status value of the input terminal so decided as the reset terminal R is stored as an operation value (operation S311).

Next, details of the processes at operation S310 and operation S311, that is, the procedures of the reset terminal deciding process according to the first embodiment will be described in accordance with a flowchart (operation S341 to operation S345) illustrated in FIG. 12. The type decision unit 122 extracts a record in which “0” is set as the status value of an output terminal from each true value table from which the records involving the clock terminal CK, the set terminal S and the input terminals which have been decided as the clock terminal CK and the set terminal S are excluded (operation S341). Then, the type decision unit 122 takes an input terminal the type of signal into which is not found, that is, one input terminal the type of which is not yet specified out of the record extracted at operation S341 (operation S342).

Then, whether the same value “1” or “0” is set as the status values of the input terminal which has been extracted at operation S342 is decided (operation S343). When the same value “1” or “0” is set to the input terminal taken out at operation S342 (a YES route at operation S343), the type decision unit 122 decides the input terminal taken out at operation S342 as the reset terminal R, stores the value (“1” or “0”) which is set to the input terminal when it has been decided as the set terminal R (operation S344) and terminates execution of the reset terminal deciding process.

On the other hand, when the same value “1” or “0” is not set to the input terminal which has been taken out at operation S342 (a NO route at operation S343), the type decision unit 122 decides whether all the input terminals the types of signals into which are not found have been taken out of the record extracted at operation S341 (operation S345). When all the input terminals the types of which are not found are not yet taken out (a NO route at operation S345), the type decision unit 122 returns to the process at operation S342. When all the input terminals the types of which are not found have been taken out (a YES route at operation S345), the type decision unit 122 terminates execution of the reset terminal deciding process.

The records (1) and (2) and the input terminals X₁ and X₂ (the clock terminal CK and the set terminal S) are excluded as illustrated in FIG. 13, for example, in the true value table of the group G₁ in FIG. 8B. In the true value table from which the records (1) and (2) and the input terminals X₁ and X₂ are excluded, when the status values of the input terminals X₃ and X₄ are respectively set to “0” and “0”, the status value of the output terminal Q₁ is set to “0” in the record (5). On the other hand, when the status value of the input terminal X₃ is set to “1” and the status value of the input terminal X₄ other than the input terminal X₃ is set to an indefinite value X, the status value of the output terminal Q₁ is set to “0” in the record (3). Therefore, it is decided that when the status value of the input terminal X₂ is set to the specific value “1”, the status value of the output terminal Q₁ is typically set to “0” based on the record (3). Thus, the record (3) in which “0” is set as the status value of the output terminal Q₁ for the status value “1” of the input terminal X₂ is extracted. Then, the input terminal X₃ to which “1” is set as the status value is decided as the reset terminal R in the record (3).

After the decision of the reset terminal R, the type decision unit 122 excludes the reset terminal R, that is, the input terminal X₃ from the true value table (operation S312). After execution of an excluding process as described above has been terminated or when it has been decided that an input terminal for which the status of the corresponding output terminal is typically set to “0” when it is set to the specific value “1” or “0” is not present (a NO route at operation S310), the type decision unit 122 proceeds to the process at operation S313.

Which one of the set terminal S and the reset terminal R is not yet decided is decided at operation S313. When both the set terminal S and the reset terminal R have been already decided (a YES route at operation S313), the type decision unit 122 proceeds to the process at operation S315. When one of the set terminal R and the reset terminal R is not yet recognized (a NO route at operation S313), whether this terminal type decision has been executed for the first time is decided (operation S314). When it is the first one (a YES route at operation S314), the type decision unit 122 returns to the process at operation S307. When it is the second one (a NO route at operation S314), the type decision unit 122 will proceed to the process at operation S315.

The deciding processes at operation S313 and operation S314 are executed as preventive measures because it sometimes may be difficult to recognize and decide the set terminal S unless the reset terminal R is recognized before recognition of the set terminal S. When the set terminal S or the reset terminal R is not recognized after the terminal type deciding process has been executed two times, the type decision unit 122 recognizes that the set terminal S or the reset terminal R is not present in the object FF and proceeds to the next process (operation S315).

The type decision unit 122 decides that an input terminal which remains at this point of time and the type of signal into which is not found, that is, the input terminal the type of which is not found is the data terminal D at operation S315. Then, the type decision unit 122 records a combination of the value of the data terminal D with the value of the corresponding output terminal (operation S316). Incidentally, in the first embodiment, it is supposed that n data terminals D₁, D₂, . . . , and Dₙ are installed in the object FF as illustrated in FIG. 15A and FIG. 16A.

Two records (4) and (5) which remain in a state that the records (1), (2) and (3) and the input terminals X₁, X₂ and X₃ (the clock terminal CK, the set terminal S and the reset terminal R) are excluded as illustrated in FIG. 13 are extracted in the true value table of the group G₁ illustrated, for example, in FIG. 8B. Then, the input terminal X₄ in each of the records (4) and (5) is decided as the data terminal D₁.

Then, the type decision unit 122 decides whether execution of the process on all the true value tables divided by the true value table division unit 121 has been completed (operation S317), and when execution of the process is not yet completed (a NO route at operation S317), it returns to the process at operation S310. When execution of the process on all the true value tables is completed (a YES route at operation S317), the type decision unit 122 terminates execution of the terminal type deciding process.

### [1-3-5] Procedures of Signal Pattern Generating Process and Delay Measuring Process

Next, the procedures of the signal pattern generating process at operation S40, the procedures of the delay measuring process at operation S50 and the FF delay library 40 generated at operation S60 in FIG. 4 will be described with reference to FIG. 14 to FIG. 16.

First, the procedures of the signal pattern generating process executed by the generation unit 123 at operation S40 and the procedures of the delay measuring process executed by the library generation unit 13 at operation S50 will be described in accordance with a flowchart (operation S501 to operation S511) illustrated in FIG. 14.

One true value table is selected from within true value tables the types of terminals in which have been already decided (operation S501). The generation unit 123 recognizes the input terminals CK, S, R and D and the output terminals Qᵢ and Qᵢ′ that belong to the group corresponding to the selected true value table with reference to the types of respective terminals in the selected true value table. Then, the generation unit 123 invalidates signals which are respectively input into the set terminal S and the reset terminal R (operation S502). That is, the generation unit 123 makes signals to be output to the output terminals Qᵢ and Qᵢ′ changeable by setting “0”s to the set terminal R and the reset terminal R.

Then, the generation unit 123 generates a signal pattern such that a value with which the output terminal Qᵢ is set “H” (hold) is set to the clock terminal CK in a state that “1” is output to the output terminal Qᵢ (operation S503). Then, the generation unit 123 sets a value with which “0” is output to the output terminal Qᵢ is set to the data terminal Dᵢ and generates the signal pattern so as to change the value of the clock terminal CK (operation S504). The value of the output terminal Qᵢ falls from “1” to “0” and the value of the output terminal Qᵢ′ rises from “0” to “1” with changing the value of the clock terminal CK.

The signals at the output terminals Qᵢ and Qᵢ′ undergo fall transition and rise transition with signal transition at the clock terminal CK by generating the signal pattern and setting it to the input terminal at operation S503 and operation S504 as described above. In the above mentioned case, the library generation unit 13 calculates and measures the delay value described in the following item (c1) (operation S505) and calculates and measures the setup time and the hold time described in the following items (c2) and (c3) (operation S506) using a simulator. The measured delay value, setup time and hold time are recorded in the storage unit 20 to generate the FF delay library 40. The generation unit 123 and the library generation unit 13 implement the functions described in the above item (b1) in the above mentioned manner.

(c1) The delay value (the delay time from signal transition at the clock terminal to transition of an output signal at each of the output terminals) from the clock terminal CK to each of the output terminals Qᵢ and Qᵢ′

(c2) The setup time (a minimum time for which the data signal to be sent to the data terminal is to be held after signal transition at the clock terminal) of the data terminal Dᵢ to the clock terminal CK

(c3) The hold time (a minimum time for which the data signal to be sent to the data terminal is to be held in advance prior to signal transition at the clock signal) of the terminal Dᵢ to the clock terminal CK

Likewise, the generation unit 123 generates a signal pattern such that a value with which the output terminal Qᵢ is set “H (hold)” is set to the clock terminal CK in a state that “0” is output to the output terminal Qᵢ (operation S507). Then, the generation unit 123 sets a value with which “1” is output to the output terminal Qᵢ is set to the data terminal Dᵢ and generates a signal pattern so as to change the value of the clock terminal CK (operation S508). The value of the output terminal Qᵢ rises from 0″ to 1″ and the value of the output terminal Qᵢ′ falls from “1” to “0” with a change of the value of the clock terminal CK as described above.

The signals of the output terminals Qᵢ and Qᵢ′ undergo rise transition and fall transition with signal transition at the clock terminal CK by generating the signal patterns and setting them for the input terminal at operation S507 and operation S508 as described above. In the above mentioned case, the library generation unit 13 calculates and measures the delay value in the above item (c1) (operation S509), and the library generation unit 13 calculates and measures the setup time and the hold time in the above items (c2) and (c3) (operation S510) using a simulator. The measured delay value, setup time and hold time are recorded in the storage unit 20 to generate the FF delay library 40. The generation unit 123 and the library generation unit 13 implement the functions described in the above item (b2) in the above mentioned manner.

Then, the generation unit 123 decides whether execution of the processes on all the true value tables the types of the terminals in which have already been decided is completed (operation S511), and when execution of the processes is not completed (a NO route at operation S511), it returns to the process at operation S501. When execution of the processes on all the true value tables the types of the terminals in which have already been decided is completed (a YES route at operation S511), the generation unit 123 and the library generation unit 13 terminate execution of the signal pattern generating and delay measuring processes.

Next, the signal pattern generating and delay measuring processes described with reference to FIG. 14 will be more specifically described with reference to FIG. 15A, FIG. 15B, FIG. 16A and FIG. 16B. Incidentally, FIG. 15A and FIG. 15B are diagrams explaining the procedures of the signal pattern generating process and the procedures of the delay measuring process according to the first embodiment. FIG. 16A and FIG. 16B are diagrams explaining the FF delay library 40 which is obtained by the procedures described in FIG. 15A and FIG. 15B.

In FIG. 15B, FIG. 16B and in the following description, “D(down)” denotes a fall transition of a signal (a value) from “1” to “0” and “U(up)” denotes a rise transition of a signal (a value) from “0” to “1”. In addition, Qᵢ(D) and Qᵢ′(D) respectively denote fall transitions of values at the output terminals Qᵢ and Qᵢ′ and Qᵢ(U) and Qᵢ′(U) respectively denote rise transitions of values at the output terminals Qᵢ and Qᵢ′ when the above mentioned notation is used. Likewise, CK(D) denotes a fall transition of a value at the clock terminal CK and CK(U) denotes a rise transition of a value at the clock terminal CK.

Here, the FF illustrated in FIG. 6 is an object for generation of the delay library 40 as illustrated in FIG. 15A and FIG. 16A. The FF includes the clock terminal CK, the set terminal S, the reset terminal R and n data terminals D₁ to Dₙ as the input terminals and the output terminals Q₁ to Qₙ and Q₁′ to Qₙ′.

The processes indicated in the following items (d1) and (d2) are executed on a first group including the clock terminal CK, the set terminal S, the reset terminal R, the data terminal D₁ and the output terminals Q₁ and Q₁′as illustrated in FIG. 15A and FIG. 15B. The processes in the item (d1) correspond to the processes at operation S503 to operation S506 in FIG. 14 and the processes in the item (d2) correspond to the processes at operation S507 to operation S510 in FIG. 14.

In the processes indicated in an item (d1), the generation unit 123 sets the data terminal D₁ to “0” (D₁=0) in a state that the respective signals are S=0, R=0, CK=1, D₁=1 (Q₁=1 and Q₁′=0). Then, the generation unit 123 sets the clock signal to “0” (CK=0) from the state D₁=0. In the above mentioned situation, the library generation unit 13 respectively measures the delay value from the clock terminal CK(D) to the output terminal Q₁(D) and the delay value from the clock terminal CK(D) to the output terminal Q₁′(U). In addition, the library generation unit 13 measures the setup time and the hold time when D₁=0 and CK=D. The delay value of CK(D)→Q₁(D), the delay value of CK(D)→Q₁′(D) and the setup time and the hold time of CK(D) vs. D₁ are recorded in the FF delay library 40 of the storage unit 20 in correspondence with D₁=0 as illustrated in FIG. 16B.

In the processes indicated in an item (d2), the generation unit 123 sets the data terminal D₁ to “1” (D₁=1) in a state that the respective signals are S=0, R=0, CK=1, D₁=1 (Q₁=0 and Q₁′=1). Then, the generation unit 123 sets the clock signal to “0” (CK=0) from the state D₁=0. In the abovementioned situation, the library generation unit 13 respectively measures the delay value from the clock terminal CK(D) to the output terminal Q₁(U) and the delay value from the clock terminal CK(D) to the output terminal Q₁₁′(D). The library generation unit 13 measures the setup time and the hold time when D₁=1 and CK=D. The delay value of CK(D)→Q₁(U), the delay value of CK(D)→Q₁′(D) and the setup time and the hold time of CK(D) vs. D₁ are recorded in the FF delay library 40 of the storage unit 20 in correspondence with D₁=1 as illustrated in FIG. 16B.

The processes indicated in items (d3) and (d4) are executed on the n-th group including the clock terminal CK, the set terminal S, the reset terminal R, the data terminal Dₙ and the output terminals Qₙ and Qₙ′ as illustrated in FIG. 15A and FIG. 15B. The processes in the item (d3) correspond to the processes at operation S503 to operation S506 in FIG. 14 as in the case of the processes in the item (d1) and the processes in the item (d4) correspond to the processes at operation S507 to operation S510 in FIG. 14 as in the case of the processes in the item (d2).

In the processes in the item (d3), the generation unit 123 sets the data terminal Dₙ to “0” (D₁=0) in a state that the respective signals are S=0, R=0, CK=1, Dₙ=1 (Qₙ=1 and Qₙ′=0). Then, the generation unit 123 sets the clock signal to “0” (CK=0) from the state Dₙ=0. In the above mentioned situation, the library generation unit 13 respectively measures the delay value from the clock terminal CK(D) to the output terminal Qₙ(D) and the delay value from the clock terminal CK(D) to the output terminal Qₙ′(U). The library generation unit 13 measures the setup time and the hold time when Dₙ=0 and CK=D. The delay value of CK(D)→Qₙ(D), the delay value of CK(D)→Qₙ′(D) and the setup time and the hold time of CK(D) vs. Dₙ are recorded in the FF delay library 40 of the storage unit 20 in correspondence with Dₙ=0 as illustrated in FIG. 16B.

In the processes in the item (d4), the generation unit 123 sets the data terminal Dₙ to “1” (Dₙ=1) in a state that the respective signals are S=0, R=0, CK=1, D₁=1 (Qₙ=0 and Qₙ′=1). Then, the generation unit 123 sets the clock signal to “0” (CK=0) from the state Dₙ=0. In the above mentioned situation, the library generation unit 13 respectively measures the delay value from the clock terminal CK(D) to the output terminal Qₙ(U) and the delay value from the clock terminal CK(D) to the output terminal Qₙ′(D). The library generation unit 13 measures the setup time and the hold time when Dₙ=1 and CK=D. The delay value of CK(D)→Qₙ(U), the delay value of CK(D)→Qₙ′(D) and the setup time and the hold time of CK(D) vs. Dₙ are recorded in the FF delay library 40 of the storage unit 20 in correspondence with Dₙ=1 as illustrated in FIG. 16B.

Although illustration and description of the processes to be executed on the second to the n-1st groups are omitted in FIG. 15 and FIG. 16, the processes which are substantially the same as the processes (d1) to (d4) executed on the first and the n-th groups are executed on the second to the n-1st groups. As a result, as for the i-th group (i=2, . . . , and n-1), the delay value of CK(D)→Qᵢ(D), the delay value of CK(D)→Qᵢ′(U) and the setup time and the hold time of CK(D) vs. Dᵢ are measured and results of measurement are recorded in the FF delay library 40 in correspondence with Dᵢ=0. Likewise, the delay value of CK(D)→Qᵢ(U), the delay value of CK(D)→Qᵢ′(D) and the setup time and the hold time of CK(D) vs. Dᵢ are measured and results of measurement are recorded in the FF delay library 40 in correspondence with Dᵢ=1.

### [1-4] Effects of Delay Library Generation Device according to First Embodiment

According to the delay library generation device 1A of the first embodiment, the output terminals and the input terminals of the object FF are combined with one another to form groups and group-based signal pattern generation and delay information measurement are automatically performed. Owing to the above, the FF delay library 40 may be automatically generated in a short time without person's help.

In particular, a range of influence of a signal for each input terminal belonging to each group is limited to the output terminals belonging to each group in each group so formed by grouping. Therefore, the amount of calculation for generation of the FF delay library 40 may be preferably reduced by group-based generation of the signal pattern and the simulation pattern for each input terminal as described above, as compared with a case that combinations of signals for all the input terminals of the object FF are simultaneously considered.

In addition, since the type of each input terminal in the FF circuit information and the true value table is automatically decided and recognized and the signal pattern and the simulation pattern for each input terminal are automatically generated, automatic generation of the FF delay library 40 may be realized. Thus, the FF delay library 40 may be automatically generated in a short time without person's help.

### [2] Description of Second Embodiment

### [2-1] Configuration of Delay Library Generation Device according to Second Embodiment

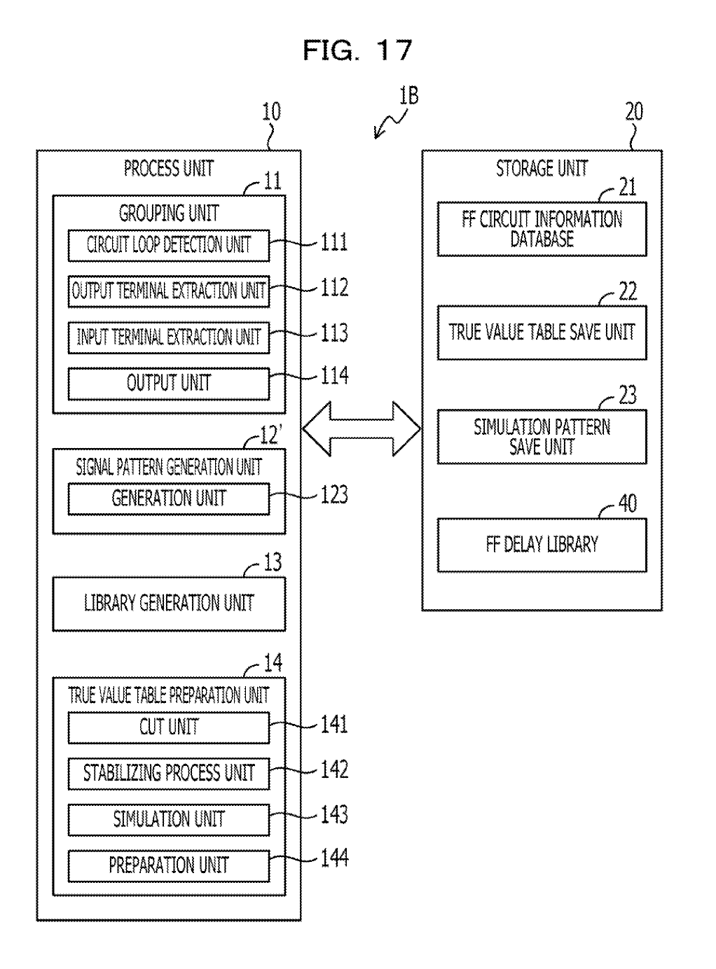

FIG. 17 is a block diagram illustrating an example functional configuration of a delay library generation device 1B according to the second embodiment. Although in the above mentioned first embodiment, a case that the true value table of the object FF is present and is provided in advance has been described, the second embodiment applies to a case that the true value table of the object FF is not present. Therefore, in the second embodiment, there is provided a function of preparing the true value table of the object FF to generate the FF delay library 40 as will be described later.

The delay library generation device 1B illustrated in FIG. 17 generates the delay library 40 of the object FF similarly to the delay library generation device 1A according to the first embodiment, and the delay library generation device 1B is configured by a computer such as a general personal computer or the like, for example. In addition, the delay library generation device 1B also includes the process unit 10 and the storage unit 20 as in the first embodiment, and the delay library generation device 1B further includes a man machine interface (not illustrated) which is operated by a user to input various kinds of information into the delay library generation device 1B.

The process unit 10 executes a delay library generation program to function as the grouping unit 11 and the library generation unit 13 which are substantially the same as those in the first embodiment and also function as a later described signal pattern generation unit 12′ and the true value table preparation unit 14.

The storage unit 20 includes the FF circuit information database 21 and the FF delay library 0 which are substantially the same as those in the first embodiment, and the storage unit 20 also includes the true value table save unit 22 and a simulation pattern save unit 23.

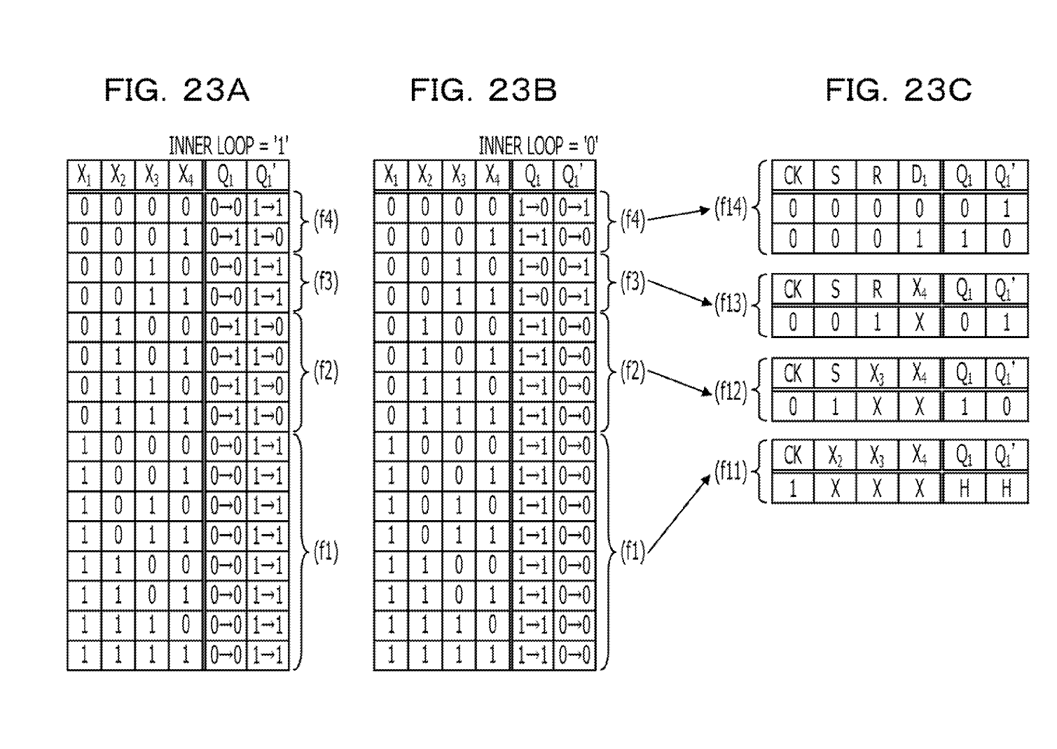

In the second embodiment, the FF delay library 40 is generated by the delay library generation device 1B. The true value table save unit 22 saves the true value table which is generated by the later described true value table preparation unit 14. The simulation pattern save unit 23 saves a simulation pattern (see FIG. 23A and FIG. 23B) used in preparation of the true value table by the true value table preparation unit 14 per group as described later.

To which one of the input terminal and the output terminal the terminal of the FF object corresponds may be identified in the FF circuit information and also in the simulation pattern according to the second embodiment as in the FF circuit information and the true value table according to the first embodiment. In addition, the FF circuit information and the simulation pattern include terminal identification information Q₁, Q₁′, Q₂, Q₂′, . . . , and Qₙ, Qₙ′ used to specify the respective output terminals and the respective output terminals are specified by the terminal identification information Q₁, Q₁′, Q₂, Q₂′, . . . , and Qₙ, Qₙ′.

The FF circuit information and the simulation pattern also include terminal identification information X₁, X₂, . . . , and Xₘ that may allow specification of respective input terminals and the respective input terminals are specified by the terminal identification information X₁, X₂, . . . , and Xₘ. However, the FF circuit information and the simulation pattern do not include information used to specify the type of each input terminal, that is, to specify to which one of the clock terminal, the set terminal, the reset terminal and the data terminal each input terminal corresponds. That is, although a corresponding relation between an input terminal in the FF circuit information illustrated in FIG. 6 and an input terminal in the simulation pattern of the object FF illustrated in FIG. 23A and FIG. 23B is recognized, no semantics are given to the input terminal information in the FF circuit information and the simulation pattern and the type of each input terminal is not recognized. Therefore, in the delay library generation device 1B, decision and recognition of the type of each input terminal are performed substantially simultaneously with preparation of the true value table illustrated in FIG. 23C from the simulation patterns illustrated in FIG. 23A and FIG. 23B by the later described true value table preparation unit 14 (a preparation unit 144).

Next, functions that the process unit 10 according to the second embodiment performs as the grouping unit 11, the signal pattern generation unit 12′, the library generation unit 13 and the true value table preparation unit 14 will be described in detail.

The grouping unit 11 combines output terminals of an object FF with input terminals of the object FF that influence the output terminals to form groups based on FF circuit information of the object FF as in the case in the first embodiment. Since the grouping unit 11 has the functions as the circuit loop detection unit 111, the output terminal extraction unit 112, the input terminal extraction unit 113 and the output unit 114 as in the case in the first embodiment, description thereof will be omitted.

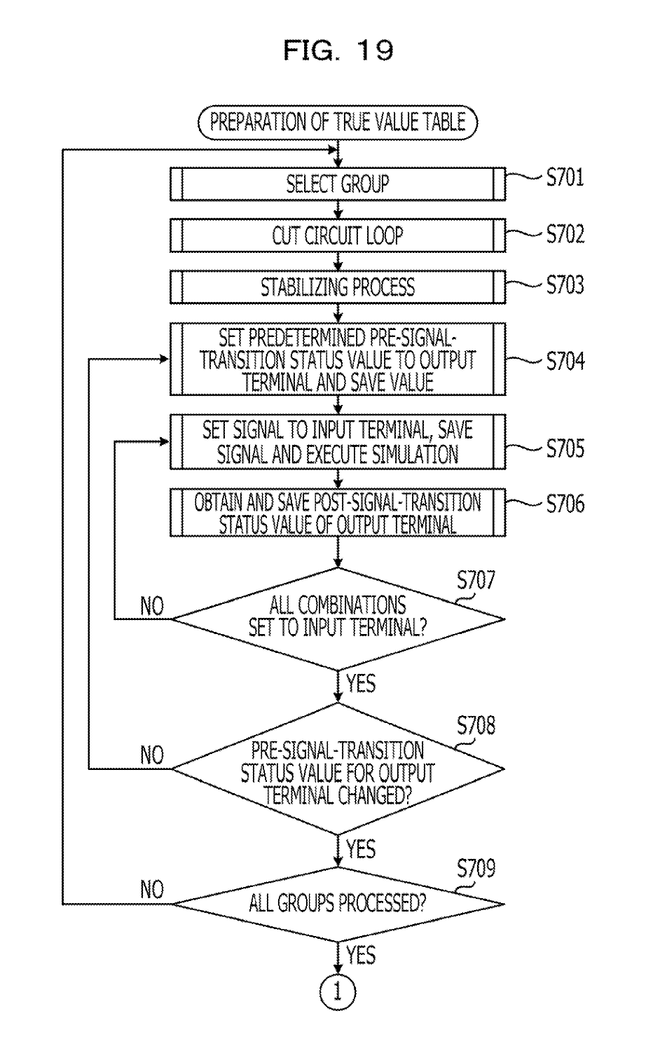

The true value table preparation unit 14 prepares true value tables of the object FF per group based on the groups obtained by the grouping unit 11. The true value table preparation unit 14 has the functions as a cut unit 141, a stabilizing process unit 142, a simulation unit 143 and the preparation unit 144 which will be described later. Specific functions and operations of the true value table preparation unit 14 including the cut unit 141, the stabilizing process unit 142, the simulation unit 143 and the preparation unit 144 will be described later with reference to FIG. 19 to FIG. 23.

The signal pattern generation unit 12′ generates signal patterns for the input terminals of the object FF per group based on the groups obtained by the grouping unit 11 and the true value tables generated by the true value table preparation unit 14. In the second embodiment, the true value table is generated by the true value table preparation unit 14 in the divided form to be used for the respective groups and the types of the input terminals are recognized in advance. Therefore, the signal pattern generation unit 12′ according to the second embodiment needs no functions as the true value table division unit 121 and the type decision unit 122 in the first embodiment, and the signal pattern generation unit 12′ simply has the function as the generation unit 123. The generation unit 123 generates signal patterns for the input terminals of the object FF, that is, simulation patterns for preparation of a delay library per group based on the types of the input terminals that the true value table preparation unit 14 has decided as in the case in the first embodiment.

The library generation unit 13 measures delay information per group based on the signal patterns that the signal pattern generation unit 12′ has generated per group and generates the delay library 40 of the object FF from a result of measurement.

Incidentally, the basic generating function which is performed by the generation unit 123 and the basic generating function which is performed by the library generation unit 13 based on the signal patterns that the generation unit 123 has generated are as indicated in the above mentioned items (b1) and (b2). In addition, since the specific functions and operations of the generation unit 123 and the library generation unit 13 are as described with reference to FIG. 14 to FIG. 16 in the explanation of the first embodiment, description thereof will be omitted.

Next, the functions as the cut unit 141, the stabilizing process unit 142, the simulation unit 143 and the preparation unit 144 included in the true value table preparation unit 14 and the function of the simulation pattern save unit 23 included in the storage unit 20 will be described.

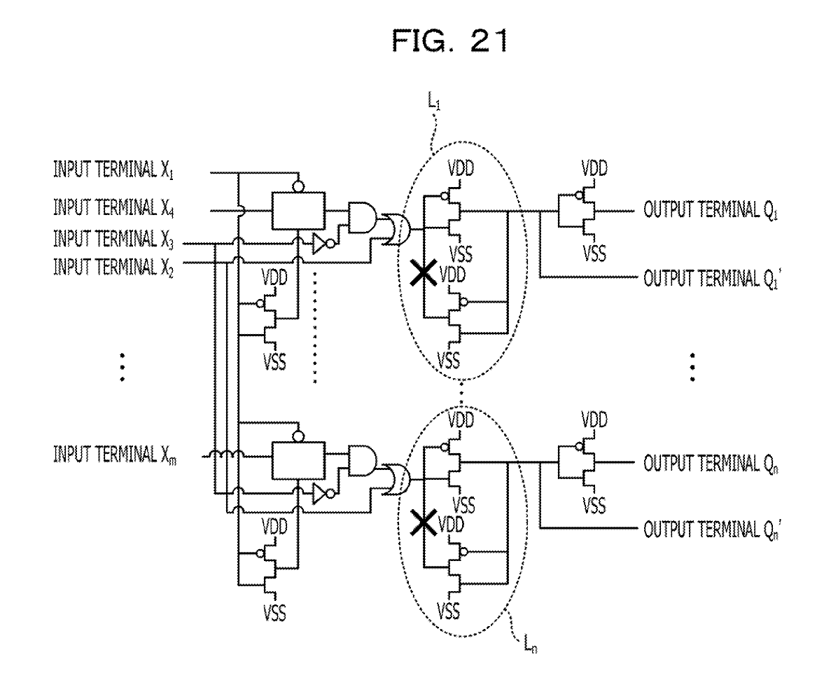

The cut unit 141 detects a circuit loop that holds a signal in the object FF from the circuit information of the object FF in the same manner as that of the circuit loop detection unit 111 which has been described in the first embodiment and cuts the detected circuit loop before the simulation unit 143 starts simulation. In the above mentioned case, if the circuit loop is present when logical simulation is to be performed, the signal will circulate and oscillate through the circuit loop. Therefore, it becomes desirable to avoid such a situation as described above by taking some measures. Basically, a circuit loop of an FF appears as a circuit element for holding a signal. Thus, cutting of the circuit loop may not adversely affect a result of logical simulation executed. Therefore, in the second embodiment, logical simulation that the simulation unit 143 executes may be facilitated and accelerated by detecting the circuit loop of the object FF and performing circuit correction that the circuit loop is cut and removed on the object FF by the cut unit 141 prior to execution of the logical simulation. The specific functions and operations of the cut unit 141 will be described later with reference to FIG. 21.

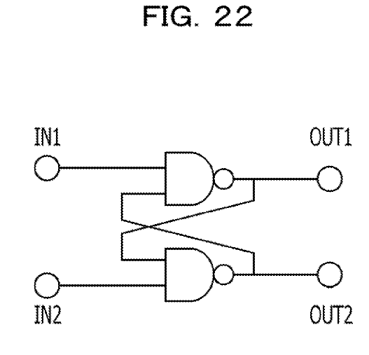

The stabilizing process unit 142 sets an indefinite value X which is present in the object FF to “0” or “1”. In particular, in the second embodiment, the stabilizing process unit 142 sets the indefinite value X which is present in the object FF to “0” or “1” when an arbitrary status value has been given to the object FF to induce transition before the simulation unit 143 starts simulation. The specific functions and operations of the stabilizing process unit 142 will be described later with reference to FIG. 22.

The simulation unit 143 performs the following simulating operation. That is, the simulation unit 143 sets an appropriate status value to an input terminal belonging to a group concerned per group so as to set a specified status value “1” or “0” to an output terminal belonging to the group. Then, the simulation unit 143 sets an arbitrary status value to the input terminal belonging to the group so as to transit the status of the input terminal from the above appropriate status value to the arbitrary status value to obtain the status value of the output terminal after signal transition. In the above mentioned case, the simulation pattern save unit 23 of the storage unit 20 saves the status value which is set to the input terminal concerned and the status values of the output terminal obtains before and after signal transition for the input terminal which are set and obtained by the simulation unit 143 based on the status value of the input terminal per group as a simulation pattern with respect to all combinations of status values which are set to the input terminal concerned as arbitrary status values. The specific functions and operations of the simulation unit 143 will be described later with reference to operation S704 to operation S709 in FIG. 19, FIG. 23A and FIG. 23B.

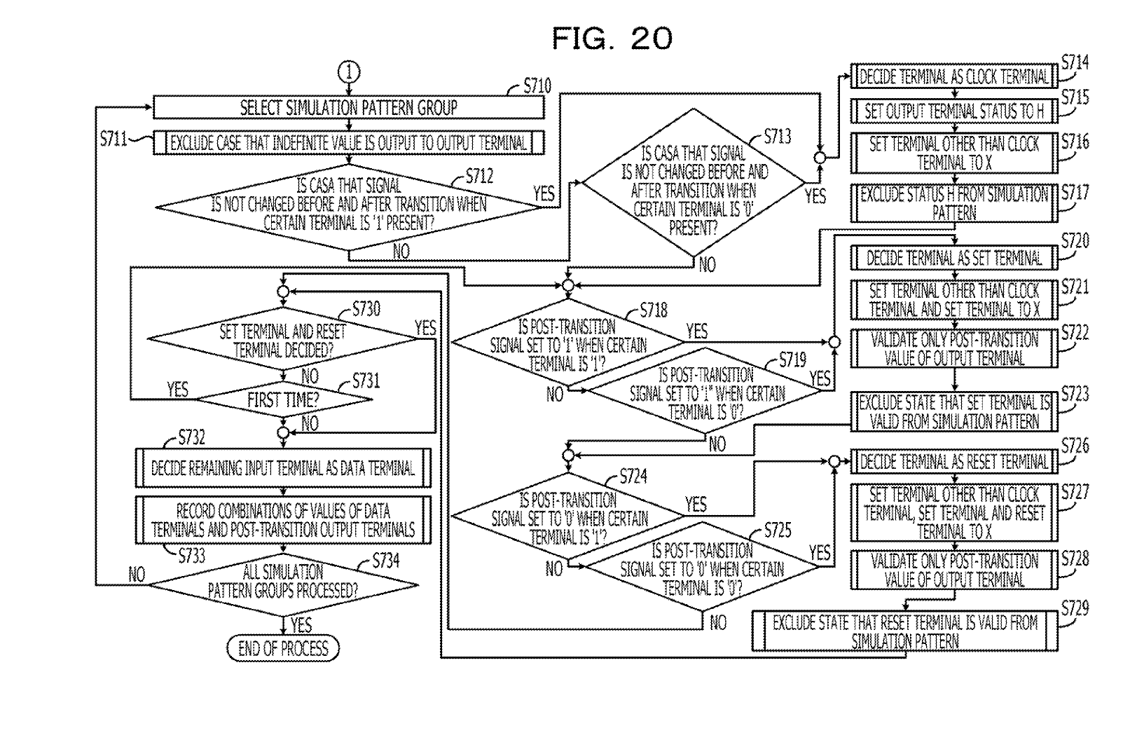

The preparation unit 144 decides the type of each input terminal in the simulation pattern concerned based on the simulation pattern of a certain one group and prepares the true value table for the group involving the simulation pattern concerned based on a result of decision. The basic deciding function and true value table preparing function of the preparation unit 144 are as indicated in the following items (e1) to (e4). The specific functions and operations of the preparation unit 144 will be described later with reference to operation S710 to operation S734 in FIG. 20 and FIG. 23A to FIG. 23C.

(e1) When a certain input terminal has been set to a specified status value “1” or “0” in a simulation pattern concerned and then when a change is not found between status values of an output terminal obtained before and after signal transition for the input terminal, the preparation unit 144 decides the input terminal concerned as the clock terminal. Then, the preparation unit 144 sets the specified status value “1” or “0” as the status value of the clock terminal in the true value table of a group involving the simulation pattern concerned and sets “H (hold)” as the status value of the output terminal. In addition, the preparation unit 144 sets “X (an indefinite value)” as the status value of an input terminal other than the input terminal concerned which has been decided as the clock terminal in the true value table. Clock terminal decision and true value table preparation as mentioned above will be described later with reference to operation S712 to operation S717 in FIG. 20 and the item (f1) in FIG. 23.

(e2) The preparation unit 144 excludes the record involving the clock terminal and the input terminal which has been decided as the clock terminal from the simulation pattern concerned and then, when a certain input terminal in the remaining input terminals except the above input terminal has been set to the specified status value “1” or “0” and then when the status value of the output terminal which is obtained after signal transition for the input terminal is set to “1”, the preparation unit 144 decides the input terminal as the set terminal. Then, the preparation unit 144 sets the specified status value “1” or “0” as the status value of the set terminal in the true value table of the group involving the simulation pattern concerned, and the preparation unit 144 sets the status value “1” which is obtained after the signal transition as the status value of the output terminal in the true value table. In addition, the preparation unit 144 sets “X (an indefinite value)” as the status value of an input terminal other than the input terminals which have been decided as the clock terminal and the set terminal. Set terminal decision and true value table preparation as mentioned above will be described later with reference to operation S718 to operation S723 in FIG. 20 and the item (f2) in FIG. 23.

(e3) The preparation unit 144 excludes the records involving the clock terminal, the set terminal and the input terminals which have been decided as the clock terminal and the set terminal from the simulation pattern concerned. Then, when a certain input terminal in the remaining input terminals is set to a specified status value, and if the status value of the output terminal which is obtained after signal transition for the input terminal is set to “0”, the preparation unit 144 decides the input terminal as the reset terminal. Then, the preparation unit 144 sets the specified status value as the status value of the reset terminal and sets the status value “0” which is obtained after signal transition as the status value of the output terminal in the true value table of the group involving the simulation pattern concerned. In addition, the preparation unit 144 sets “X (an indefinite value)” as the status value of an input terminal other than the input terminals which have been decided as the clock terminal, the set terminal and the reset terminal in the true value table. Reset terminal decision and true value table preparation as mentioned above will be described later with reference to operation S724 to operation S729 in FIG. 20 and the item (f3) in FIG. 23.

(e4) The preparation unit 144 decides input terminals which remain undecided as data terminals in the simulation pattern concerned. Then, the preparation unit 144 sets the status values in the simulation pattern concerned as status values of the data terminals and the status values of the output terminals in the true value table of the group involving the simulation pattern concerned. Data terminal decision and true value table preparation as mentioned above will be described later with reference to operation S732 and operation S733 and the item (f4) in FIG. 23.

### [2-2] Operation of Delay Library Generation Device according to Second Embodiment

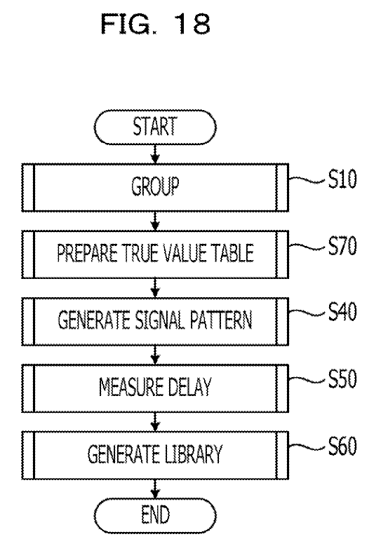

Next, the functions and operations of the delay library generation device 1B configured as described above according to the second embodiment will be described with reference to FIG. 18 to FIG. 23A and FIG. 23B. The delay library generation device 1B according to the second embodiment generates the FF delay library 40 used upon execution of the above mentioned delay analysis with reference to FIG. 2 and FIG. 3 as in the case in the first embodiment. However, each true value table is generated for each group as described above in the device 1B according to the second embodiment when the true value table for the object FF is not present. In the following, the procedures of a true value table preparing process will be described in detail, in particular.

### [2-2-1] Outline of Procedures of Delay Library Preparing Process

The outline of the procedures of the delay library preparing process executed by the delay library generation device 1B according to the second embodiment will be described in accordance with a flowchart (operation S10, operation S70, operation S40 to operation S60) illustrated in FIG. 18.

First, the grouping unit 11 combines output terminals of an object FF with input terminals of the object FF that influence the output terminals to form groups based on FF circuit information of the object FF as in the first embodiment (operation S10; the grouping operation).

Then, the true value table preparation unit 14 prepares the true value tables of the object FF per group based on the groups obtained at operation S10 and stores them in the true value table save unit 22 of the storage unit 20 (operation S70; the true value table preparing operation). The procedures of the true value table preparing process at operation S70 will be described in detail later with reference to FIG. 19 to FIG. 23A and FIG. 23B.

Then, the generation unit 123 of the signal pattern generation unit 12′ generates signal patterns for the input terminals of the object FF, that is, simulation patterns for preparation of the delay library per group based on the groups obtained at operation S10 and the true value tables generated per group at operation S70 as in the first embodiment (operation S40; the signal pattern generating operation).

Then, the library generation unit 13 measures delay values and setup times and hold times per group as delay information based on the signal patterns so generated per group at operation S40 (operation S50) and the delay library 40 of the object FF is generated from a result of measurement executed and is stored in the storage unit 20 (operation S60; the library generating operation).

### [2-2-2] Procedures of True Value Table Preparing Process

Next, the procedures of the true value table preparing process that the true value table preparation unit 14 executes at operation S70 in FIG. 18 will be described with reference to FIG. 21 to FIG. 23A and FIG. 23B in accordance with the flowcharts in FIG. 19 and FIG. 20 (operation S701 to operation S734). Incidentally, FIG. 21 illustrates example cutting of a circuit loop according to the second embodiment, FIG. 22 illustrates an example indefinite value correcting process as a stabilizing process according to the second embodiment, and FIG. 23A to FIG. 23C illustrate example procedures of simulation pattern preparing and true value table preparing processes according to the second embodiment.

First, the true value table preparation unit 14 selects one group from a plurality of groups that the grouping unit 11 has formed at operation S10 (operation S701). The cut unit 141 performs forward tracing starting from an input terminal belonging to the selected group to detect a circuit loop with reference to the circuit information of the object FF involving the selected group. For example, in the FF illustrated in FIG. 21, the circuit loop L₁ is detected in the first group and the circuit loop Lₙ , is detected in the n-th group as in the case of the FF illustrated in FIG. 6. Then, the cut unit 141 cuts the circuit loop Li (i=1, 2, . . . , and n) so detected in each group at a position marked with “X” in FIG. 21 to remove the circuit loop from the object FF, for example (operation S702).

The stabilizing process unit 142 gives an arbitrary status value to a terminal in the group on which circuit correction as mentioned above has been performed to remove the circuit loop to induce transition, and the stabilizing process unit 142 sets the indefinite value X to “0” or “1” when an indefinite value X is present in the object FF (operation S703). When the indefinite value X is output from the object FF after simulation has been performed by setting the value to the terminal, the stabilizing process unit 142 sets a value “0” to an arbitrary indefinite value output portion, for example, and then the simulation unit 143 executes regular simulation. When the indefinite value remains at a portion that “0” is not set, the stabilizing process unit 142 sets “0” to the portion. For example, when a circuit as illustrated in FIG. 22 is present in the object FF, even if simulation is executed supposing that IN1=“1” and IN2=“1”, OUT1=X (an indefinite value) and OUT2=X (an indefinite value) will be obtained. In the above mentioned case, if the stabilizing process unit 142 sets OUT1=“0”, OUT1=“0” and OUT2=“1” will be obtained in the next simulation. Thus, the status in the object FF will be stabilized and succeeding simulation may be stably and adequately executed.

Then, the simulation unit 143 executes the processes (operation S704 to operation S709) on the selected group. In the following, a case that the true value table of the first group of the object FF illustrated in FIG. 6 and FIG. 18, that is, the group that includes four input terminals X₁, X₂, X₃ and X₄ the types of which are not yet decided and two output terminals Q₁ and Q₁′ is generated will be described.

First, the simulation unit 143 sets “0” and “1” to the output terminals Q₁ and Q₁′ as specified pre-signal-transition status values by setting appropriate status values to the input terminals X₁, X₂, X₃ and X₄ so as to set “1” to the internal loop L₁. Then, the simulation unit 143 saves the status values “0” and “1” which have been set to the output terminals Q₁ and Q₁′ in the save unit 23 as the simulation patterns as indicated on the left side of “→” in each column of the output terminals Q₁ and Q₁′ in FIG. 23A (operation S704).

Then, the simulation unit 143 sets arbitrary status values to the four input terminals X₁, X₂, X₃ and X₄, and the simulation unit 143 saves the arbitrary status values in the storage unit 23 as the simulation patterns as indicated in the columns of the input terminals X₁, X₂, X₃ and X₄ in FIG. 23A to execute simulation (operation S705).

The simulation unit 143 obtains the status values of the output terminals Q₁ and Q₁′ after signal transition for the input terminal has been induced in association with execution of the simulation. That is, the simulation unit 143 makes the status values of the input terminals X₁, X₂, X₃ and X₄ transit from the above appropriate status values to the above arbitrary status values to obtain the status values of the output terminals Q₁ and Q₁′ in association with the signal transition. Then, the simulation unit 143 saves the obtained status values in the save unit 23 as the simulation patterns as indicated on the right side of “→” in each column of the output terminals Q₁ and Q₁′ in FIG. 23A (operation S706).

The processes at operation S705 and operation S706 are repetitively executed until all the combinations of the status values, that is, sixteen combinations of status values illustrated in FIG. 23A are set to the four input terminals X₁, X₂, X₃ and X₄ (a NO route at operation S707). The simulation patterns of sixteen records as illustrated in FIG. 23A are obtained at the completion of setting of all the combinations of status values. Incidentally, one record is a one-line element in each simulation pattern. The simulation unit 143 that has completed setting of all the combinations of status values (an YES route at operation S707) decides whether the specified pre-signal-transition status values to be set to the output terminals Q₁ and Q₁′ have been changed (operation S708).

When the pre-signal-transition status values to be set to the output terminals Q₁ and Q₁′ are not changed (a NO route at operation S708), the simulation unit 143 sets “1” and “0” to the output terminals Q₁ and Q₁′ as the specified pre-signal-transition status values by setting appropriate status values to the input terminals X₁, X₂, X₃ and X₄ so as to set “0” to the internal loop L₁. Then, the simulation unit 143 saves the status values “1” and “0” which have been set to the output terminals Q₁ and Q₁′ in the save unit 23 as the simulation patterns as indicated on the left side of “→” in each column of the output terminals Q₁ and Q₁′ in FIG. 23B (operation S704). The simulation unit 143 may obtain simulation patterns of sixteen records as illustrated in FIG. 23B by repeating execution of the processes at operation S705 to operation S707 in the above mentioned state.

When it has been decided that the specified pre-signal-transition status values are changed at operation S708 (a YES route), the simulation unit 143 decides whether the processes at operation S702 to operation S708 have been executed on all the groups (operation S709). When not-processed groups are present (a NO route at operation S709), the simulation unit 143 returns to the process at operation S701, selects one group from the not-processed groups and executes the processes at operation S702 to operation S708 on the selected group.

When execution of the processes on all the groups has been terminated (a Yes route at operation S709), the simulation unit 143 terminates execution of the simulating operation. At this point of time, simulation pattern groups as illustrated in FIG. 23A and FIG. 23B are saved in the simulation pattern save unit 23 of the storage unit 20 per group.

When the simulation unit 143 terminates execution of the simulating operation, the preparation unit 144 is activated and one simulation pattern group is selected from the simulation pattern groups in the simulation pattern save unit 23 of the storage unit 20 (operation S710). Here, it is supposed that the simulation pattern groups for the first group illustrated in FIG. 23A and FIG. 23B are selected.

The preparation unit 144 excludes a case that an indefinite value X is output to each of the output terminals Q₁ and Q₁′ in the selected simulation pattern groups (operation S711). Incidentally, such a case (a record) as mentioned above is not present in the simulation pattern groups in FIG. 23A and FIG. 23B.

Then, the preparation unit 144 decides whether a case that a change is not found between status values of each of the output terminals Q₁ and Q₁′ obtained before and after signal transition for the input terminal when the set value of a certain input terminal is “1” is present in the simulation pattern concerned (operation S712). When the case that the change is not found between the status values is not present (a NO route at operation S712), the preparation unit 144 decides whether a case that a change is not found between the status values of each of the output terminals Q₁ and Q₁′ obtained before and after signal transition when the set value of a certain input terminal is “0” is present (operation S713). When it has been decided that the case that the change is not found between the status values is present at operation S712 or S713 (a YES route), the preparation unit 144 decides the input terminal concerned as the clock terminal CK (operation S714). For example, in the simulation patterns in FIG. 23A and FIG. 23B, it is judged that the change is not found between the status values of each of the output terminals Q₁ and Q₁′ when the input terminal X₁ is “1” based on the records in areas (f1) and the input terminal X₁ is decided as the clock terminal CK.

Then, the preparation unit 144 sets “1” as the status value of the clock terminal CK in the true value table of the simulation pattern concerned as indicated in a record (f11) in FIG. 23C and sets “H (hold)” as the status value of each of the output terminals Q₁ and Q₁′ (operation S715). In addition, the preparation unit 144 sets “X (an indefinite value)” as the status value of each of the input terminals X₂, X₃ and X₄ other than the input terminal X₁ which has been decided as the clock terminal CK in the true value table as indicated in the record (f11) in FIG. 23C (operation S716). Then, the preparation unit 144 excludes the record in which the status is “H (hold)” from the simulation pattern concerned (operation S717). For example, in the simulation patterns illustrated in FIG. 23A and FIG. 23B, the records in the areas (f1) are excluded and succeeding processes are executed.

When NO at operation S713 or after execution of the process at operation S717 has been terminated, the preparation unit 144 decides whether a case that the status value of the output terminal Q₁ obtained after signal transition for the input terminal turns to “1” when the set value of a certain input terminal is “1” is present in the simulation pattern concerned (operation S718). When the case that the status value turns to “1” is absent (a NO route at operation S718), the preparation unit 144 decides whether a case that the status value of the output terminal Q₁ turns to “1” when the set value of a certain input terminal is “0” is present (operation S719). When it has been decided that the case that the status value turns to “1” is present at operation S718 or S719 (a YES route), the preparation unit 144 decides the input terminal concerned as the set terminal S (operation S720). For example, in the in the simulation patterns in FIG. 23A and FIG. 23B, it is decided that the status value of the output terminal Q₁ turns to “1” when the input terminal X₂ is “1” based on the records in areas (f2) and the input terminal X₂ is decided as the set terminal S.

Then, the preparation unit 144 sets “0” as the status value of the clock terminal CK and sets “1” as the status value of the set terminal S in the true value table of the simulation pattern concerned as indicated in a record (f12) in FIG. 23C. In addition, the preparation unit 144 sets “X (an indefinite value)” as the status value of each of the input terminals X₃ and X₄ other than the input terminals X₁ and X₂ the types of which have already been decided in the true value table as indicated in the record (f12) in FIG. 23C (operation S721). Further, the preparation unit 144 respectively sets the post-signal-transition values “1” and “0” in the true value table as the status values of the output terminals Q₁ and Q₁′ as indicated in the record (f12) in FIG. 23C (operation S722). Then, the preparation unit 144 excludes the record in which the set terminal S is valid from the simulation pattern concerned (operation S723). For example, in the simulation patterns illustrated in FIG. 23A and FIG. 23B, the records in the areas (f2) are excluded and succeeding processes are executed.

When NO at operation S719 or after execution of the process at operation S723 has been terminated, the preparation unit 144 decides whether a case that the status value of the output terminal Q₁ obtained after signal transition for the input terminal turns to “0” when the set value of a certain input terminal is “1” is present in the simulation pattern concerned (operation S724). When the case that the status value turns to “0” is absent (a NO route at operation S724), the preparation unit 144 decides whether a case that the status value of the output terminal Q₁ turns to “0” when the set value of a certain input terminal is “0” is present (operation S725). When it has been decided that the case that the status value turns to “0” is present at operation S724 or S725 (a YES route), the preparation unit 144 decides the input terminal concerned as the reset terminal R (operation S726). For example, it is decided that the status value of the output terminal Q₁ turns to “0” when the input terminal X₃ is “1” based on the records in areas (f3) and the input terminal X₃ is decided as the reset terminal R in the in the simulation patterns in FIG. 23A and FIG. 23B.

Then, the preparation unit 144 sets “0” as the status value of the clock terminal CK, sets “0” as the status value of the set terminal S and sets “1” as the status value of the reset terminal R in the true value table of the simulation pattern concerned as indicated in a record (f13) in FIG. 2C, respectively. In addition, the preparation unit 144 sets “X (an indefinite value)” as the status value of the input terminal X₄ other than the input terminals X₁, X₂ and X₃ the types of which have already been decided in the true value table as indicated in the record (f13) in FIG. 23C (operation S727). Further, the preparation unit 144 respectively sets the post-signal-transition values “0” and “1” in the true value table as the status values of the output terminals Q₁ and Q₁′ as indicated in the record (f13) in FIG. 23C (operation S728). Then, the preparation unit 144 excludes the record in which the reset terminal R is valid from the simulation pattern concerned (operation S729). For example, in the simulation patterns illustrated in FIG. 23A and FIG. 23B, the records in the areas (f3) are excluded and succeeding processes are executed.

When NO at operation S719 or after execution of the process at operation S723 has been terminated, the preparation unit 144 decides which one of the set terminal S and the reset terminal R remains undecided (operation S730). When the types of both the set terminal S and the rest terminal R have already been decided (a YES route at operation S730), the preparation unit 144 proceeds to the process at operation S732. When the type of one of the set terminal S and the reset terminal R is not yet recognized (a NO route at operation S730), it is decided that the process has been executed for the first time (operation S731). When it is decided to be the first one (a YES route at operation S731), the preparation unit 144 returns to the process at operation S718. When it is decided to the second one (a NO route at operation S731), it proceeds to the process at operation S332.

Here, the deciding processes at operation S730 and operation S731 are executed because it sometimes may be difficult to recognize and decide the set terminal S unless the reset terminal R is recognized prior to recognition of the set terminal S as in the processes at operation S313 and operation S314 in FIG. 9. When the set terminal S or the reset terminal R is not recognized even when the processes at operation S718 to operation S729 are executed two times, the preparation unit 144 considers that the set terminal S or the reset terminal R is not present in the object FF and proceeds to the next process (operation S732).

The preparation unit 144 decides the remaining input terminal the type of signal to which is not found, that is, the input terminal the type of which is not yet specified at this point of time as the data terminal D at operation S732. Then, the preparation unit 144 records combinations of the value of the data terminal D with the post-transition status values of the output terminals Q₁ and Q₁′ (operation S733). For example, as the not-decided input terminal X₄ is decided as the data terminal D₁, and the preparation unit 144 sets two records (f14) illustrated in FIG. 23C in the true value table of the simulation pattern concerned based on four patterns in areas (f4) in the simulation patterns in FIG. 23A and FIG. 23B. As a result, the true value table of the first group corresponding to the true value table in FIG. 13 is generated from the records (f11) to (f14) in FIG. 23C. The generated true value table is recorded in the true value table save unit 22 of the storage unit 20.

Then the preparation unit 144 decides whether execution of the processes on all the simulation pattern groups has been completed (operation S734). When not yet completed (a NO route at operation S734), the preparation unit 144 returns to the process at operation S710. When completed (a YES route at operation S734), the preparation unit 144 terminates execution of the true value table preparing process.

### [2-3] Effects of Delay Library Generation Device according to Second Embodiment

According to the delay library generation device 1B of the second embodiment, operational effects as follows may be obtained in addition to the operational effects which are substantially the same as those obtained in the first embodiment. That is, in the second embodiment, when a true value table is not generated for an FF as an object of preparation of the delay library 40, the output terminals and the input terminals of the object FF are combined with one another to form groups and the true value table is automatically generated per group. As a result, the true value table of each group, that is, the true value table of the object FF may be automatically generated in a shorter time than ever.

In particular, in the respective groups so formed as described above, the influence range of signals to the input terminals belonging to each group is limited to the output terminals belonging to the same group as the input terminals. Thus, the amount of calculation for preparation of the true value table may be favorably reduced by preparing the true value table per group, as compared with a case in which combinations of signals for all the input terminals in the object FF are simultaneously considered.

In addition, the types of the input terminals in the FF circuit information and the simulation pattern group are automatically decided and recognized and the true value tables of the respective groups and signal patterns and simulation patterns for the input terminals are automatically generated as described above. Accordingly, even when any true value table is not present, the process of generating the FF delay library 40 including preparation of the true value table may be wholly automatically executed.

In addition, in the second embodiment, the circuit loop of the object FF is detected by the cut unit 141 and circuit correction for cutting off the circuit loop is performed on the object FF prior to execution of the logical simulation. As a result, a process of suppressing oscillation of a signal caused by the circuit loop may be readily executed and the logical simulation may be readily executed by the simulation unit 143 at a high speed.

Further, in the second embodiment, the indefinite value X which is present in the object FF is set to “0” or “1” for the group from which the circuit loop is removed by performing circuit correction as mentioned above by the stabilizing process unit 142. As a result, the status in the object FF is stabilized and succeeding logical simulation may be stably and adequately executed.

### [3] Others

Although preferred embodiments of the present invention have been described so far, the present invention is not limited to specific embodiments as mentioned above and may be embodied by being altered and modified in a variety of ways within a range not departing from the scope of the present invention.

Incidentally, although in the above mentioned embodiments an FF of the type including the clock terminal CK, the set terminal S, the reset terminal R and n data terminals D₁ to Dₙ as the input terminals and the output terminals Q₁ to Qₙ and Q₁′ to Qₙ′ is adopted as an object, the object that the present invention handles is not limited to an FF of the type as mentioned above.

In addition, all or some of the functions as the grouping unit 11, the signal pattern generation units 12 and 12′, the library generation unit 13 and the true value table preparation unit 14 may be implemented by executing a specified application program (a delay library generation program) by a computer (including a CPU, an information processing device and various terminals).

The program is provided in a state that it is recorded in a computer readable recording medium such as, for example, a flexible disk, a CD (including a CD-ROM, a CD-R, a CD-RW and the like), a DVD (including a DVD-ROM, a DVD-RAM, a DVD-R, a DVD-RW, a DVD+R, a DVD+RW, a Blu-ray® Disc-ROM and the like) and the like. In the above mentioned case, the computer reads the program out of the recording medium concerned, transfers the program to an internal storage or an external storage and stores the program in it for future use.

Here, the computer is a concept including hardware and an OS (Operating System) and means hardware that operates under the control of the OS. In addition, when the OS is not needed and the hardware is operated with an application program alone, the hardware itself corresponds to the computer. The hardware includes at least a microprocessor such as a CPU or the like and means for reading a computer program recorded in a recording medium. The above mentioned delay library generation program includes a program code that makes a computer of the type as mentioned above implement the functions of the above mentioned respective units 11 to 15 and 12′. Some of the functions may be implemented by the OS in place of the application program.

All examples and conditional language recited herein are intended for pedagogical objects to aid the reader in understanding the invention and the concepts contributed by the inventor to furthering the art, and are to be construed as being without limitation to such specifically recited examples and conditions. Although the embodiment(s) of the present inventions have been described in detail, it should be understood that the various changes, substitutions, and alterations could be made hereto without departing from the spirit and scope of the invention.

What is claimed is:

1. A delay library generation device comprising:
a grouping unit that generates a group including an output terminal of a sequential logic circuit and an input terminal of the sequential logic circuit that influences the output terminal based on circuit information of the sequential logic circuit;
a signal pattern generation unit that generates a signal pattern set for the input terminal of the sequential logic circuit for each generated group based on a true value table of the sequential logic circuit; and
a library generation unit that measures a delay of the sequential logic circuit for each group and generates a delay library of the sequential logic circuit based on the measured delay.

2. The delay library generation device according to claim 1, wherein
the grouping unit comprises:
a circuit loop detection unit that detects a circuit loop in the sequential logic circuit that keeps a signal value based on the circuit information of the sequential logic circuit;
an output terminal extraction unit that extracts an output terminal of the sequential logic circuit connected with the detected circuit loop from the circuit information of the sequential logic circuit by tracing forward the sequential logic circuit from the detected circuit loop;
an input terminal extraction unit that extracts an input terminal that influences the extracted output terminal from the circuit information of the sequential logic circuit by tracing backward the sequential logic circuit from the extracted output terminal and; and
an output unit that groups the extracted output terminal with the extracted input terminal and outputs the grouped terminals.

3. The delay library generation device according to claim 1, wherein
the signal pattern generation unit comprises:
a true value table division unit that divides the true value table of the sequential logic circuit into a plurality of divided true value tables for each generated group;
a type decision unit that decides the type of the extracted input terminal for each generated group based on each divided true value table; and
a generation unit that generates a signal pattern for an input terminal of the sequential logic circuit for each generated group based on the decided type of the input terminal.

4. The delay library generation device according to claim 3, wherein
the type decision unit extracts a record in which a hold value is set as a status value of an output terminal in the true value table of the sequential logic circuit, and decides an input terminal to which the status value is set in all the extracted records as a clock terminal.

5. The delay library generation device according to claim 4, wherein
the type decision unit extracts a record in which a first specified value is set as the status value of the output terminal in the true value table from which the record including the input terminal decided as the clock terminal has been excluded, and decides an input terminal to which the same first specified value is set in all the extracted records as a set terminal.

6. The delay library generation device according to claim 5, wherein
the type decision unit extracts a record in which a second specified value different with the first specified value is set as the status value of the output terminal in the true value table from which the record including the input terminal corresponding to the decided clock terminal is excluded, and decides an input terminal to which the second specified value is set in the extracted records as a reset terminal.

7. The delay library generation device according to claim 6, wherein
the type decision unit decides a remaining input terminal in the extracted records from which the decided clock terminal, the decided set terminal and the decided reset terminal are excluded as a data terminal.

8. The delay library generation device according to claim 7, wherein
the generation unit generates a first signal pattern that is set for an input terminal to make the status value of the output terminal transit from the first specified value to the second specified value for each generated group in accordance with the decision by the type decision unit , and
the library generation unit measures a delay value from the clock terminal to the output terminal and a setup time and a hold time from the data terminal to the clock terminal as the delay information when the status value of the output terminal is made to transit from the first specified value to the second specified value based on the first signal pattern.

9. The delay library generation device according to claim 7, wherein
the generation unit generates a second signal pattern that is set for an input terminal to make the status value of the output terminal transit from the second specified value to the first specified value for each generated group in accordance with the decision by the type decision unit, and
the library generation unit measures a delay value from the clock terminal to the output terminal and a setup time and a hold time from the data terminal to the clock terminal as the delay information when the status value of the output terminal is made to transit from the second specified value to the first certain value based on the second signal pattern.

10. The delay library generation device according to claim 1, further comprising:
a true value table preparation unit that generates a group true value table of the sequential logic circuit for each generated group, wherein
the signal pattern generation unit generates a signal pattern for an input terminal of the sequential logic circuit for each generated group based on the generated group true value table.

11. The delay library generation device according to claim 10, wherein
the true value table preparation unit comprises:
a simulation unit that performs a simulation of making the status value of the input terminal belonging to a target group transit to an arbitrary status value such that a specified status value is set to the output terminal belonging to the target group and obtain the status value of the output terminal belonging to the target group for each generated group;
a save unit that saves pre-transition status value and post-transition status value of an input terminal belonging to the target group and pre-transition status value and post-transition status value of the output terminal belonging to the target group which are obtained by the simulation unit as a simulation pattern for each generated group with respect to all combinations of status values set as the arbitrary status values to the input terminal belonging to the target group; and
a preparation unit that generates a group true value table for each generated group based on the saved simulation pattern.

12. The delay library generation device according to claim 11, wherein
the preparation unit decides the type of an input terminal in the simulation pattern based on the simulation pattern which is saved for each generated group and generates a group true value table of the simulation pattern for each generated group based on the decided type of the input terminal.

13. The delay library generation device according to claim 12, wherein
the type decision unit decides an input terminal as a clock terminal when the status value of the output terminal is not changed with transition of the status value of the input terminal to which a specified status value is set in the simulation pattern saved for each group, and sets the specified status value as the status value of the clock terminal, sets the hold value as the status value of the output terminal, and sets an indefinite value as the status value of an input terminal other than the input terminal decided as the clock terminal in the group true value table of the simulation pattern saved for each group.

14. The delay library generation device according to claim 13, wherein
the type decision unit decides an input terminal as a set terminal when the status value of an output terminal is not changed with transition of the status value of the input terminal to which the specified status value transits to the first specified value in the simulation pattern saved for each group, and sets the specified status value as the status value of the set terminal, sets the first specified value as the status value of the output terminal and sets an indefinite value as a status value of an input terminal other than the input terminal decided as the clock terminal and the set terminal in the group true value table of the simulation pattern saved for each group.

15. The delay library generation device according to claim 13, wherein
the type decision unit decides an input terminal as a reset terminal when the status value of an output terminal is not changed with transition of the status value of the input terminal to which the specified status value transits to the second specified value in the simulation pattern saved for each group, and sets the specified status value as the status value of the reset terminal, sets the second specified value as the status value of the output terminal and sets an indefinite value as a status value of an input terminal other than the input terminal decided as the clock terminal and the reset terminal in the group true value table of the simulation pattern saved for each group.

16. The delay library generation device according to claim 14, wherein
the type decision unit decides a remaining input terminal in the simulation pattern from which the decided clock terminal, the decided set terminal and the decided reset terminal are excluded as a data terminal.

17. The delay library generation device according to claim 11, wherein
the true value table preparation unit further comprises:
a cut unit that detects a circuit loop that keeps a signal value in the sequential logic circuit based on the circuit information of the sequential logic circuit, and cuts the detected circuit loop before the simulation unit start the simulation.

18. The delay library generation device according to claim 11, wherein
the true value table preparation unit further comprises:
a stabilizing process unit that sets an indefinite value that is set for the sequential logic circuit to a value zero or a value one.

19. A delay library generation method comprising:
generating a group including an output terminal of a sequential logic circuit and an input terminal of the sequential logic circuit that influences the output terminal based on circuit information of the sequential logic circuit;
generating a signal pattern for the input terminal of the sequential logic circuit for each generated group based on a true value table of the sequential logic circuit;
measuring a delay of the sequential logic circuit per group based on the generated signal pattern; and
generating a delay library of the sequential logic circuit based on the measured delay.

20. A non-transitory computer-readable medium storing a delay library generation program causing a computer to execute a process, the process comprising:
generating a group including an output terminal of a sequential logic circuit and an input terminal of the sequential logic circuit that influences the output terminal based on circuit information of the sequential logic circuit;
generating a signal pattern for the input terminal of the sequential logic circuit for each generated group based on a true value table of the sequential logic circuit;
measuring delay information indicating a delay of the sequential logic circuit per group based on the generated signal pattern; and generating a delay library of the sequential logic circuit based on the measured delay information.
